(19) United States
(12) Patent Application Publication
(10) Pub. No.: US 2019/0302895 A1
(43) Pub. Date: Oct. 3, 2019

(54) HAND GESTURE RECOGNITION SYSTEM FOR VEHICULAR INTERACTIVE CONTROL

(71) Applicant: USens Inc., San Jose, CA (US)

(72) Inventors: Bokai JIANG, San Jose, CA (US); Yue FEI, San Jose, CA (US); Yaming WANG, San Jose, CA (US); Yiwen RONG, San Jose, CA (US); Tommy K. ENG, San Jose, CA (US)

(21) Appl. No.: 16/366,973

(22) Filed: Mar. 27, 2019

Related U.S. Application Data
(60) Provisional application No. 62/648,828, filed on Mar. 27, 2018.

(51) Int. Cl. G06F 3/01; G06T 7/246; G06T 7/73

(52) U.S. Cl. CPC G06F 3/017; G06T 7/248; G06F 3/167; G06T 2207/10016; G06T 2207/30196; G06T 7/74

(57) ABSTRACT

A method for hand gesture based human-machine interaction with an automobile may comprise: automatically starting a first mode of control of the automobile, wherein the first mode is associated with a first set of hand gestures, each hand gesture corresponding to a command for controlling the automobile; determining whether a trigger event has been detected; and in response to determining that the trigger event has been detected, performing control of the automobile in a second mode, wherein the second mode is associated with a second set of hand gestures, each hand gesture corresponding to a command for controlling the automobile, and wherein the first set of hand gestures and the corresponding commands are a subset of the second set of hand gestures and the corresponding commands.

### CROSS REFERENCE TO RELATED APPLICATION

This application claims the benefit of priority to U.S. Provisional Application No. 62/648,828, filed with the United States Patent and Trademark Office on Mar. 27, 2018, and entitled “HAND GESTURE RECOGNITION SYSTEM FOR VEHICULAR INTERACTIVE CONTROL,” which is hereby incorporated by reference in its entirety.

### TECHNOLOGY FIELD

The present disclosure relates to Human Machine Interface (HMI) system, in particular, to an interactive system based on a pre-defined set of human hand gestures. For example, the interactive system may capture input of human gestures and analyze the gestures to control an automotive infotainment system and to achieve the interaction between a user and the infotainment system.

### BACKGROUND

There are human-machine interfaces available in automobiles, especially in the vehicular infotainment systems. Other than the traditionally used knob and button interface, touch screens enable users to directly interact with the screens by touching them with their fingers. Voice control methods are also available for infotainment systems such as Amazon's Alexa. BMW has introduced a hand gesture control system in its 7 series models. However, such a hand gesture control system only provides a few simple control functions such as answering or rejecting an incoming call, and adjusting the volume of music playing. It does not support functions requiring either heavy user-machine interactions, visual feedbacks on a screen or a graphical user interface (GUI) to achieve the user-machine interactions, such as those interactions between a user and a computer or a smartphone.

With bigger screens being introduced to the vehicular infotainment system, it is becoming less practical to rely on only touch interaction via a touch screen to control it as it would raise ergonomic concerns and cause safety issues. Gesture control provides maximum flexibility for display screen placement, e.g., allowing the display screens' locations beyond the reach of hands of vehicle occupants in a normal sitting position. Many automotive manufactures are incorporating gesture control into their infotainment systems. However, without a standardized and effective gesture recognition and control system, consumers would be confused and discouraged from using it.

### SUMMARY

One aspect of the present disclosure is directed to a method for hand gesture based human-machine interaction with an automobile. The method may comprise: automatically starting a first mode of control of the automobile, wherein the first mode is associated with a first set of hand gestures, each hand gesture corresponding to a command for controlling the automobile; determining whether a trigger event has been detected; and in response to determining that the trigger event has been detected, performing control of the automobile in a second mode, wherein the second mode is associated with a second set of hand gestures, each hand gesture corresponding to a command for controlling the automobile, wherein the first set of hand gestures and the corresponding commands are a subset of the second set of hand gestures and the corresponding commands.

Another aspect of the present disclosure is directed to a system for hand gesture based human-machine interaction with an automobile. The system may comprise one or more processors and a memory storing instructions. The instructions, when executed by the one or more processors, may cause the system to perform: automatically starting a first mode of control of the automobile, wherein the first mode is associated with a first set of hand gestures, each hand gesture corresponding to a command for controlling the automobile; determining whether a trigger event has been detected; and in response to determining that the trigger event has been detected, performing control of the automobile in a second mode, wherein the second mode is associated with a second set of hand gestures, each hand gesture corresponding to a command for controlling the automobile, wherein the first set of hand gestures and the corresponding commands are a subset of the second set of hand gestures and the corresponding commands.

Yet another aspect of the present disclosure is directed to a non-transitory computer-readable storage medium. The non-transitory computer-readable storage medium may be coupled to a processor and comprising instructions. The instructions, when executed by the one or more processors, may cause the processors to perform a method for hand gesture based human-machine interaction with an automobile. The method may comprise: automatically starting a first mode of control of the automobile, wherein the first mode is associated with a first set of hand gestures, each hand gesture corresponding to a command for controlling the automobile; determining whether a trigger event has been detected; and in response to determining that the trigger event has been detected, performing control of the automobile in a second mode, wherein the second mode is associated with a second set of hand gestures, each hand gesture corresponding to a command for controlling the automobile, wherein the first set of hand gestures and the corresponding commands are a subset of the second set of hand gestures and the corresponding commands.

In some embodiments, the trigger event may comprise one or more of a hand gesture, a voice, a push a physical button, and a combination thereof. In some embodiments, in the second mode the method may further comprise: triggering a first command corresponding to a first hand gesture for controlling a first function of the automobile; triggering a second command corresponding to a second hand gesture for controlling a second function of the automobile, wherein the second function is performed on a foreground of a screen of the automobile, and wherein the first function is paused on a background of the screen of the automobile; detecting a switching signal, wherein the switching signal comprises one or more of a hand gesture, a voice, a push a physical button, and a combination thereof; and in response to detecting the switching signal, switching the first function to be performed on the foreground and the second function to be paused on the background.

In some embodiments, the method may further comprise: displaying an indicator on a screen of the automobile corresponding to a hand gesture of a user, wherein the hand gesture comprises a fingertip and a wrist of the user, and a position of the indicator on the screen is determined based at least on a vector formed by positions of the fingertip and wrist. In some embodiments, the screen of the automobile may comprise a grid that has a plurality of blocks, and the indicator may comprise one or more of the blocks.

In some embodiments, the method may further comprise: capturing a first video frame at a first time, the first video frame including a first position and rotation of the fingertip; capturing a second video frame at a second time, the second video frame including a second position and rotation of the fingertip; comparing the first position and rotation of the fingertip and the second position and rotation of the fingertip to obtain a movement of the fingertip from the first time to the second time; determining whether the movement of the fingertip is less than a pre-defined threshold; and in response to determining that the movement of the fingertip is less than the pre-defined threshold, determining the position of the indication on the screen at the second time as the same as the position at the first time.

In some embodiments, the method may further comprise: capturing a first video frame at a first time, the first video frame including a first position and rotation of the wrist; capturing a second video frame at a second time, the second video frame including a second position and rotation of the wrist; comparing the first position and rotation of the wrist and the second position and rotation of the wrist to obtain a movement of the wrist from the first time to the second time; determining whether the movement of the wrist is less than a pre-defined threshold; and in response to determining that the movement of the wrist is less than the pre-defined threshold, determining the position of the indication on the screen at the second time as the same as the position at the first time.

In some embodiments, the method may further comprise: collecting data related to a user of the automobile, wherein the commands corresponding to the hand gestures are also based at least on the collected data. In some embodiments, the method may further comprise: assigning a hot-keys tag to one or more functions of the automobile controlled by the commands; and generating a hot-keys menu that comprises the one or more functions with hot-keys tags.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

Features and advantages consistent with the disclosure will be set forth in part in the description which follows, and in part will be obvious from the description, or may be learned by practice of the disclosure. Such features and advantages will be realized and attained by means of the elements and combinations particularly pointed out in the appended claims. The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 schematically shows an environment for gesture control based interaction system according to an exemplary embodiment.

FIG. 2 schematically shows a hand gesture control module according to an exemplary embodiment.

FIG. 3 is a flow diagram showing an interaction process based on gesture control according to an exemplary embodiment.

FIG. 4 is a flow diagram showing function triggering and switching based on gesture tracking according to an exemplary embodiment.

FIG. 5 is a flow diagram showing hand gesture identification and corresponding actions according to an exemplary embodiment.

FIG. 6 is a flow chart showing an interaction processes based on gesture tracking according to an exemplary embodiment.

FIG. 7 is a block diagram illustrating an example computing system in which any of the embodiments described herein may be implemented.

FIG. 8 is a flow diagram showing interactions under two different modes according to an exemplary embodiment.

FIG. 9 schematically shows a process of defining, assigning and adjusting hot-keys controlled functions according to an exemplary embodiment.

FIG. 10 is a flow diagram showing context sensitive suggestion integrated with gesture tracking GUI according to an exemplary embodiment.

FIG. 11 is a flow diagram showing the use of button and/or voice input in combination with gesture tracking to control the interaction according to an exemplary embodiment.

FIG. 12 is a diagram schematically showing a combination of physical button, haptic feedback, eye tracking and gesture control according to an exemplary embodiment.

FIG. 13 is a diagram schematically showing a combination of voice and gesture control according to an exemplary embodiment.

FIG. 14 is a graph showing a hand gesture of five fingers swiping up to turn on full-access gesture tracking according to an exemplary embodiment.

FIG. 15 schematically shows switching between functions according to an exemplary embodiment.

FIG. 16 is a graph showing a hand gesture of two fingers swiping left to switch functions according to an exemplary embodiment.

FIG. 17 is a graph showing a hand gesture of two fingers swiping right to switch functions according to an exemplary embodiment.

FIG. 18 shows a move and selection of a quantity according to an exemplary embodiment.

FIG. 19 is a graph showing a hand gesture of two fingers swiping left and holding to decrease a quantity according to an exemplary embodiment.

FIG. 20 is a graph showing a hand gesture of two fingers swiping right and holding to increase a quantity according to an exemplary embodiment.

FIG. 21 is a graph showing a hand gesture of a palm facing down with all fingers extended then closed up to make a fist, enabling control in a 3D GUI according to an exemplary embodiment.

FIG. 22 is a graph showing a hand gesture of a finger pointing and holding to select a function according to an exemplary embodiment.

FIG. 23A schematically shows a clockwise rotation according to an exemplary embodiment.

FIG. 23B is a graph showing a hand gesture of two fingers extending and rotating clockwise to increase a quantity according to an exemplary embodiment.

FIG. 24A schematically shows a counter-clockwise rotation according to an exemplary embodiment.

FIG. 24B is a graph showing a hand gesture of two fingers extending and rotating counter-clockwise to decrease a quantity according to an exemplary embodiment.

FIG. 25 is a graph showing a hand gesture of one finger tapping to click or activate a function according to an exemplary embodiment.

FIG. 26 is a graph showing a hand gesture of four fingers tapping to cancel a function according to an exemplary embodiment.

FIG. 27 is a graph showing a hand gesture of changing from fist to palm to disengage gesture tracking according to an exemplary embodiment.

FIG. 28 is a graph showing a hand gesture of palm up and then rolling up two fingers to call out a menu according to an exemplary embodiment.

FIG. 29 schematically shows an interaction controlled under a cursor mode according to an exemplary embodiment.

FIG. 30 schematically shows an interaction controlled under a grid mode according to an exemplary embodiment.

FIG. 31 schematically shows an algorithm controlling screen navigation according to an exemplary embodiment.

FIG. 32 schematically shows customizable gesture control according to an exemplary embodiment.

FIG. 33 shows the tracking of critical points on a hand with one or more degrees of freedom to form a skeletal model according to an exemplary embodiment.

FIG. 34 schematically shows a three-dimensional (3D) GUI according to an exemplary embodiment.

### DESCRIPTION OF THE EMBODIMENTS

The present disclosure comprises of a gesture control system and method for automobile control by driver and passengers. For example, the gesture based control of the automobile may comprise operations of the automobile, e.g., driving, parking, etc. Hand gestures may be identified by the system to control the automobile to move forward, slow down, speed up, park in a garage, back into a parking spot, etc. The gesture based control of the automobile may also comprise controlling of other operation components of the automobile, e.g., controlling of lighting, windows, doors, trunk, etc. In addition, the gesture based control of the automobile may comprise in-cabin control, e.g., controlling of infotainment system of the automobile. The gesture control system and method are based on a pre-defined set of hand gestures. Many common functions in the cabin of a vehicle may be controlled by using the gesture control system and method, such as climate control, radio, phone calls, navigation, video playing, etc.

The gesture control system and method may define interactions between a user and the automobile (including operation components and infotainment system). For example, the system and method may define how the gesture control system is turned on, and how the automobile reacts to certain gestures. The gesture control system and method may also allow users to customize the functions of gestures. Further, physical button and/or voice command may be combined with the gestures to control the infotainment system. The system and method may provide feedback in response to user gestures through various audio (e.g., sound effect, tone, voice, etc.), haptic (e.g., vibration, pressure, resistance, etc.), or visual means.

The gesture control system and method may automatically start a first mode of control of the automobile. The first mode of control of the automobile may also referred to as “a quick access mode” hereinafter. In the first mode, limited operations of the automobile may be controlled by the gesture control system. The system and method may define a first set of hand gestures (also referred to as “always-on quick-access gestures” or “quick access gestures”) to automatically control the infotainment system or other parts of the automobile in the first mode without turning on a second mode (also referred to as “a full-access gesture tracking mode”). For example, a first set of hand gestures may correspond to commands for controlling non-moving operations of the automobile, e.g. lighting, windows, etc. The controlling in the first mode is limited to the operations other than those related to driving or parking of the automobile, thus avoiding safety risks. In other example, in the first mode, hand gestures may be limited to controlling simple operations of the automobile without distracting the driver. For example, the first set of hand gestures may correspond to commands for controlling lighting, windows, answering or rejecting a phone call, etc. Such operations do not require heavy visual interactions between the user and the automobile, and thus do not distract the user while the user is driving.

The gesture control system and method may detect a trigger event, e.g., a pre-defined hand gesture, through sensors (e.g., a camera) to turn on and turn off the second mode of control of the automobile, also referred to as the “full-access gesture tracking mode.” Once the gesture control system is turned on, the system and method may identify a second set of hand gestures to control full functions of the automobile, e.g., driving, parking, controlling of other operation components, controlling of the infotainment system, etc. For example, a hand gesture associated with the second mode may correspond to a command for selection of a function in the infotainment system, such as cabin climate control. The control function may also be accomplished by interacting with a GUI on a display screen by using gestures for navigation, selection, confirmation, etc. Once the function is selected, the system and method may detect pre-defined gestures to adjust certain settings. For the climate control example, when the system and method detect a pre-defined hand gesture of a user, the system and method may adjust the temperature up or down to the desired level accordingly. In another example, the system and method may allow user to customize gesture definitions by modifying currently defined gestures by the system or by adding new gestures.

In some embodiments, the gesture control system and method may provide interactions similar to those provided by a multi-touch based user interface using free-hand motion without physical contact with the screen. The gesture control system and method may also provide a precise fine-grain navigation or selection control similar to that of a cursor-based desktop user interface paradigm through free-hand motion without a physical pointing or tracking device (e.g., computer mouse).

The gesture control and method provides a consistent scalable user interaction paradigm across many different vehicle interior design ranging from conventional ones to large scale displays such as 4K display, head-up-display, seat-back display for rear passengers, drop-down/flip-down/overhead monitor, 3D display, holographic display, and windshield projection screen.

The above described functions allow users to proactively manage the infotainment system. There are certain scenarios where users react to certain events from the infotainment system by using gestures. By enforcing consistent semantic rules on gestures, only a small set of intuitive gestures is required to control all functions of a car with minimal user training. For example, the user may use the same gesture to reject a phone call in one application as well as to ignore a pop up message in another application.

Hereinafter, embodiments consistent with the disclosure will be described with reference to drawings. Wherever possible, the same reference numbers will be used throughout the drawings to refer to the same or like parts.

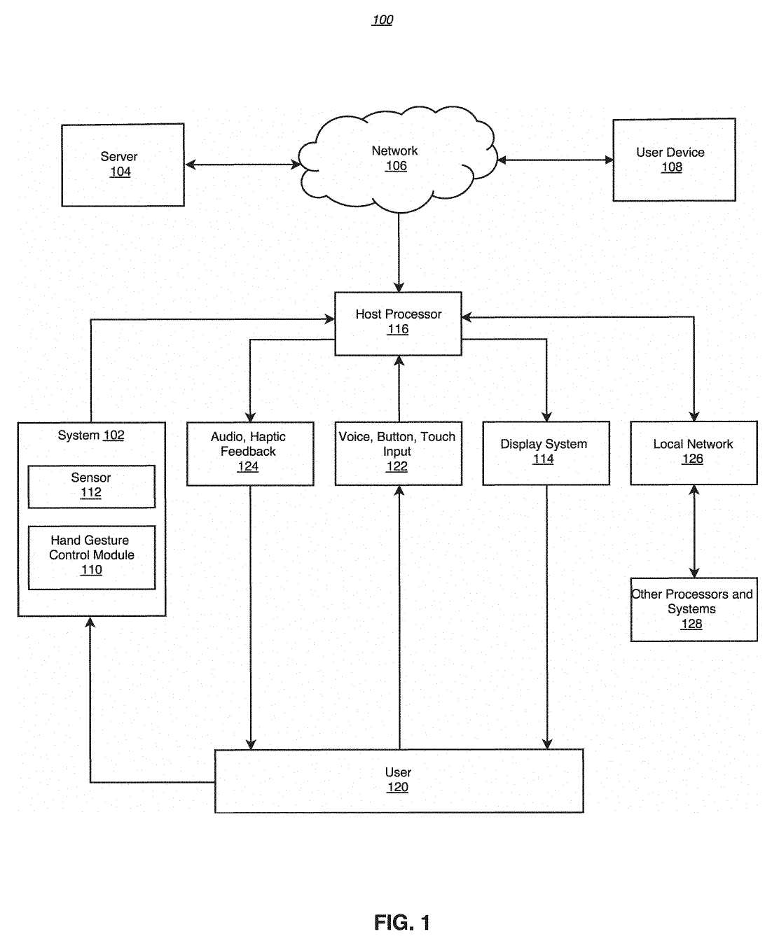

FIG. 1 schematically shows an environment 100 for gesture control based interaction system according to an exemplary embodiment. The environment 100 includes a system 102 (such as a gesture control based interaction system) interacting with a user 120, a server 104, a host processor 116, a display system (screen) 114, and a user device 108 (e.g., a client device, desktop, laptop, smartphone, tablet, mobile device). The host processor 116, the server 104 and the user device 108 may be communicative of one another through the network 106. The system 102, the host computer 116, the server 104 and the user device 108 may include one or more processors and memory (e.g., permanent memory, temporary memory). The processor(s) may be configured to perform various operations by interpreting machine-readable instructions stored in the memory. The system 102, the host computer 116, the server 104 and the user device 108 may include other computing resources and/or have access (e.g., via one or more connections/networks) to other computing resources. The host processor 116 may be used to control the infotainment system and other in-cabin functions, control the climate control system, run application programs, process gesture input from system 102, process other user input such as touch/voice/button/etc. 122, communicate with users via a graphical user interface (GUI) on a display system (screen) 114, implement a connected-car via a wireless internet connection 106, control a communication system (cellphone, wireless broadband, etc.), control a navigation system (GPS), control a driver assistance system including autonomous driving capability, communicate with other processors and systems 128 (e.g., engine control) in the vehicle via an in-car local network 126, and provide other user feedback such as sound (audio), haptic 124, etc.

While the system 102, the host processor 116, the server 104, and the user device 108 are shown in FIG. 1 as single entities, this is merely for ease of reference and is not meant to be limiting. One or more components or functionalities of the system 102, the host processor 116, the server 104, and the user device 108 described herein may be implemented in a single computing device or multiple computing devices. For example, one or more components or functionalities of the system 102 may be implemented in the server 104 and/or distributed across multiple computing devices. As another example, the sensor processing performed in the sensor module 112 and/or the hand gesture control functions performed in the hand gesture control module 110 may be offloaded to the host processor 116.

The system 102 may be a gesture control system for automobile infotainment system. The system 102 may be based on a pre-defined set of hand gestures. The control of many common functions in the infotainment system may be achieved using hand gesture control, such as climate control, radio, phone calls, navigation, video playing, etc.

The system 102 may define interactions between a user and the infotainment system. For example, the system 102 may define how the gesture control system is turned on, and how the infotainment system reacts in response to trigger events, e.g., hand gestures, voice, pushing a physical button, etc. Physical button, touch, and/or voice may also be combined with hand gestures to control the infotainment system. The system may provide feedback in response to user gestures through various audio (e.g., tone, voice, sound effect, etc.), haptic (e.g., vibration, pressure, resistance, etc.), or visual means.

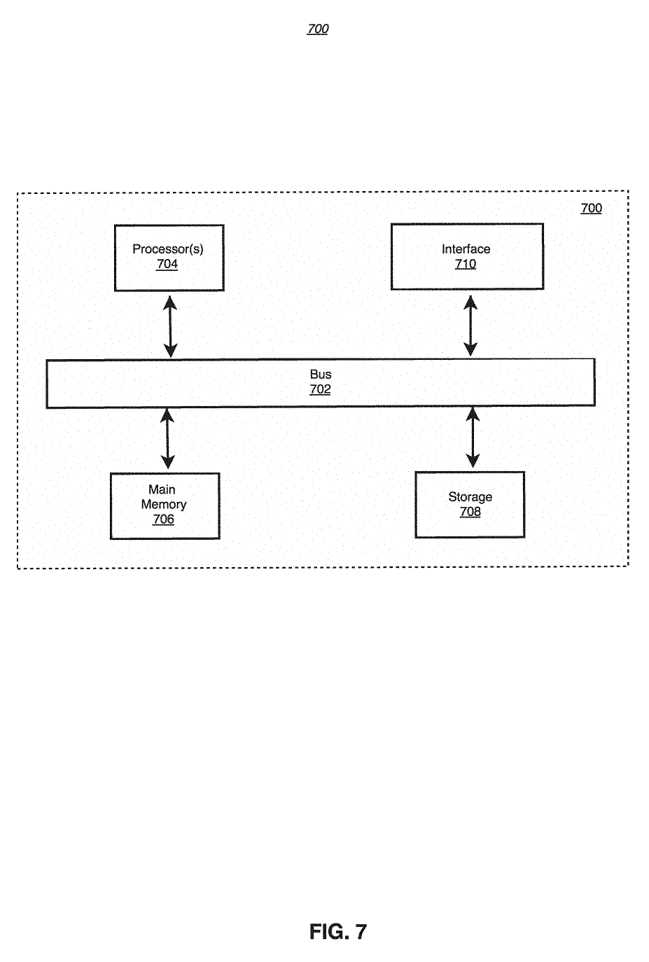

In some embodiments, the system 102 may search for pre-defined gestures to enable a full-access gesture tracking mode. In full-access gesture tracking mode, the system 102 may identify pre-defined gestures that enable selection of a function (or an application) in the infotainment system, such as climate control. The climate control function is an example of various application programs executed by a processor (such as processor 704 in FIG. 7) in the system 102. The application may have an associated GUI displayed on the display screen 114.

In some embodiments, many applications may be activated at the same time, analogous to multiple tasks executing in multiple windows on a desktop computer. The application's GUI may present users menus to select function and adjust certain settings such as temperature in the climate control system. Unlike the mouse-based interaction paradigm in desktop computing environment, the interaction between passengers and the GUI may be accomplished by free-hand gestures for navigation, selection, confirmation, etc. Once a function is selected, the system 102 may detect pre-defined gestures to adjust a current setting to a desired one based on detection of a user's hand gesture. For example, when the system 102 detects a pre-defined hand gesture of a user, the system 102 may adjust the temperature up or down to a level indicated by the hand gesture accordingly.

Examples of applications include climate control, radio, navigation, personal assistance, calendar and schedule, travel aid, safety and driver assistance system, seat adjustment, mirror adjustment, window control, entertainment, communication, phone, telematics, emergency services, driver alert systems, health and wellness, gesture library, vehicle maintenance & update, connected car, etc. Certain applications may be pre-loaded into the vehicle (and stored in a storage such as the storage 708 in FIG. 7) at the time of manufacture. Additional applications may be downloaded by users at any time (from an application store) via wireless means over the air or other means such as firmware download from USB drives.

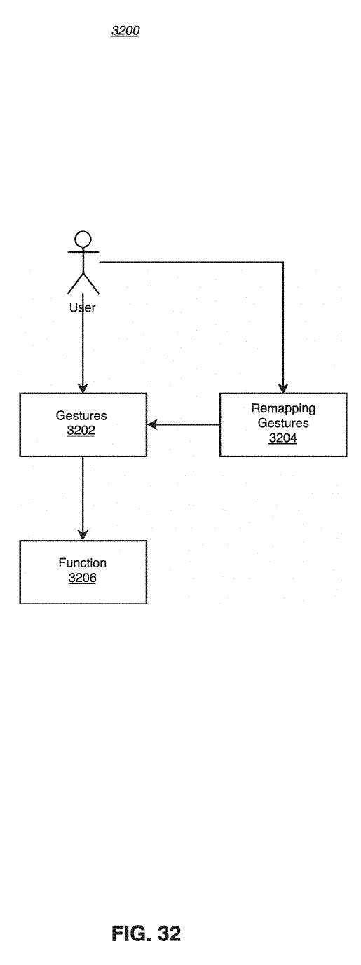

In some embodiments, the system 102 may allow user to customize gesture definitions by modifying currently defined gestures by the system or by adding new gestures. Referring to FIG. 32, schematically illustrated is a customizable gesture control according to an exemplary embodiment. A user may modify the mapping between gestures and functions (e.g., the mapping may be stored in a gesture library), and download new additions to the gesture library recognizable by the system 102.

Due to the myriad of possible applications that can potentially clutter up the display, it is useful to have quick access to some commonly used essential functions (e.g., radio, climate, phone control) without invoking full access gesture control. This way, unnecessary navigation or eye contact with specific applications GUI can be avoided.

In some embodiments, the system 102 may also define a set of always-on quick-access gestures to control the infotainment system or other parts of the automobile without turning on the full-access gesture tracking mode. Examples for the always-on quick-access gestures may include, but are not limited to, a gesture to turn on or off the radio, a gesture to turn up or down the volume, a gesture to adjust temperature, a gesture to accept or reject a phone call, etc. These gestures may be used to control the applications to provide desired results to the user without requiring the user to interact with a GUI, and thus avoiding distraction to the user (such as a driver). In some embodiments, quick-access gestures may usually not offer the full control available in an application. If a user desires finer control beyond the quick-access gestures, the user can make a gesture to pop the application up on the display screen. For example, a quick hand movement pointing towards the screen while performing a quick-access gesture for controlling the phone may bring up the phone application on the screen.

The system 102 may use the devices and methods described in U.S. Pat. No. 9,323,338 B2 and U.S. Patent Application No. US2018/0024641 A1, to capture the hand gestures and recognize the hand gestures. U.S. Pat. No. 9,323,338 B2 and U.S. Patent Application No. US2018/0024641 A1 are incorporated herein by reference.

The above described functions of the system 102 allow users to proactively manage the infotainment system. There are scenarios where users react to events from the infotainment system. For example, receiving a phone call may give users a choice of accepting or rejecting the phone call. In another example, a message from another party may pop up so the users may choose to respond to or ignore it.

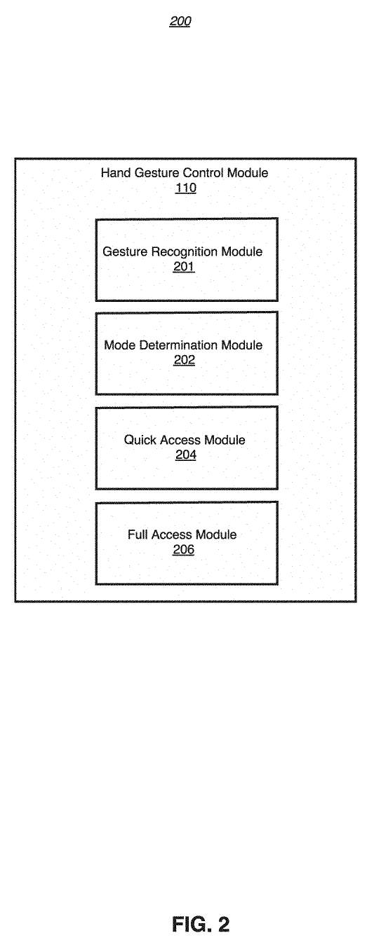

The system 102 includes a hand gesture control module 110, which is described in detail below with reference to FIG. 2, and a sensor module 112 (e.g., a camera, a temperature sensor, a humidity sensor, a velocity sensor, a vibration sensor, a position sensor, etc.) with its associated signal processing hardware and software (HW or SW). In some embodiments, the sensor module 112 may be physically separated from the hand gesture control module 110, connecting via a cable. The sensor module 112 may be mounted near the center of the dashboard facing the vehicle occupants, overhead near the rear view mirror, or other locations. While only one sensor module 112 is illustrated in FIG. 1, the system 102 may include multiple sensor modules 112 to capture different measurements. Multiple sensor modules 112 may be installed at multiple locations to present different Point of View (POV) or perspectives, enabling a larger coverage area and increasing the robustness of detection with more sensor data.

For image sensors, the sensor module may include a source of illumination in visual spectrum as well as electromagnetic wave spectrum invisible to human (e.g., infrared). For example, a camera may capture a hand gesture of a user. The captured pictures or video frames of the hand gesture may be used by the hand gesture control module 110 to control the interaction between the user and the infotainment system of the automobile.

In another example, an inertial sensing module consisting of gyroscope and/or accelerometer may be used to measure or maintain orientation and angular velocity of the automobile. Such sensor or other types of sensors may measure the instability of the automobile. The measurement of the instability may be considered by the hand gesture control module 110 to adjust the method or algorithm to perform a robust hand gesture control even under an unstable driving condition. This is described in detail below with reference to FIGS. 2, 30 and 31.

FIG. 2 schematically shows a hand gesture control module 110 according to an exemplary embodiment. The hand gesture control module 110 includes a gesture recognition module 201, mode determination module 202, a quick-access gesture control module 204, and a full-access gesture tracking module 206. Other components may be also included in the hand gesture control module 110 to achiever other functionalities not described herein.

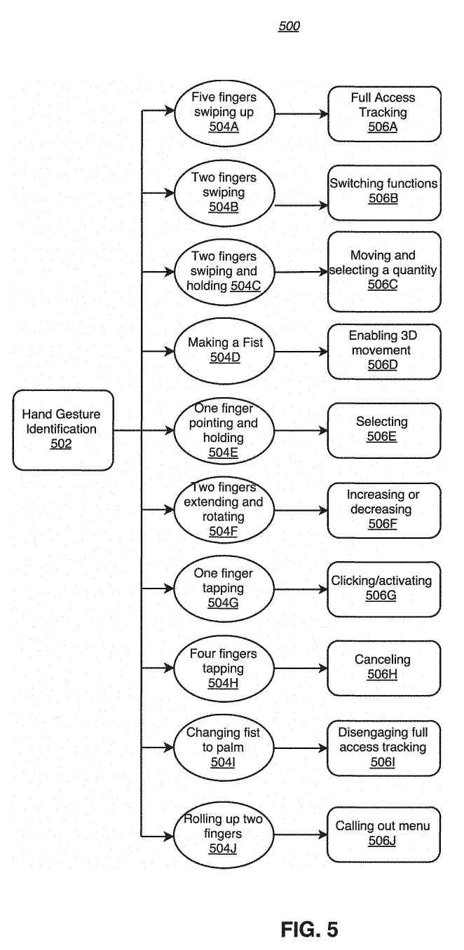

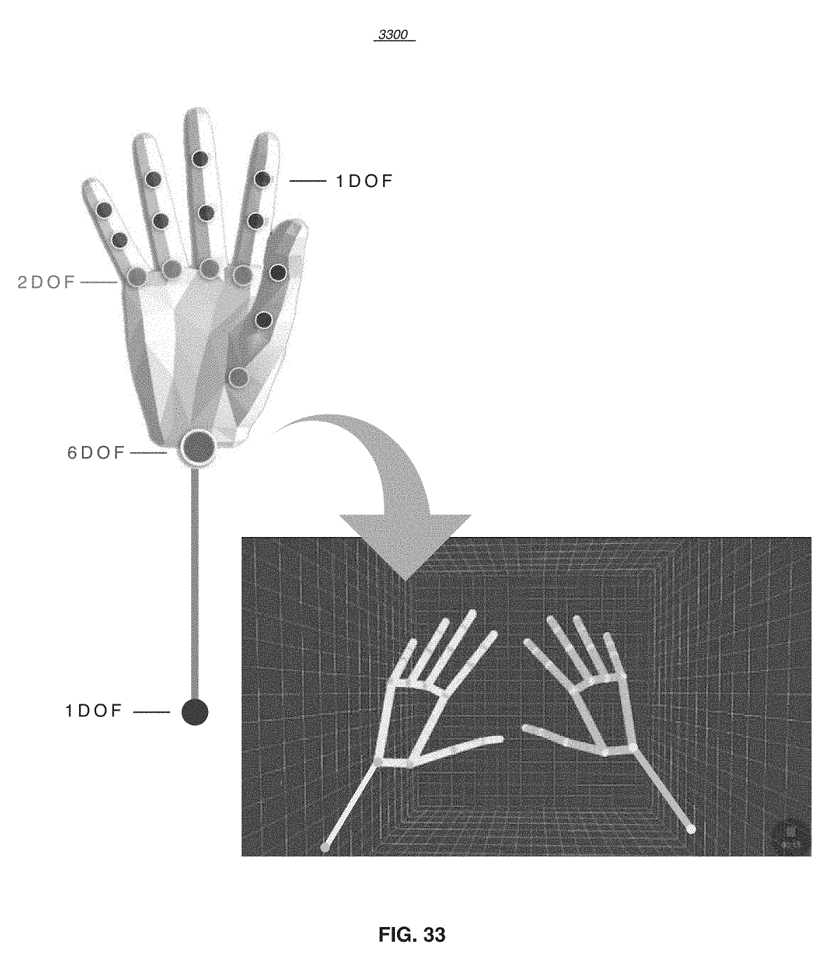

In some embodiment, the gesture recognition module 201 may receive data (e.g., point cloud, pixel color or luminosity values, depth info, etc.) from the sensor processing system 112, filter out the noise in the data, segregate hand related data points from the background, detect the presence of a hand, use the coordinates of the tracked points (such as those in FIG. 33) to form a skeletal model of the hand, and track its position and movement. Critical points on the hand and other body parts (e.g., elbow) vital to the computation of position and movement are detected, recognized, and tracked by the gesture recognition module 201. FIG. 33 illustrates joints of the hand useful for accurate tracking. A joint is chosen based on the degree(s) of freedom (DOF) it offers. FIG. 33 is an example of 26 DOF hand tracking in combination with arm tracking. Using the position of these joints, the hand gesture recognition module 201 may create a skeletal model of the hand and the elbow, which may be used to track the position or movement of the hand and/or arm in a 3D space with sufficient frame rate to track fast movement with low latency, thus achieving accurate real time hand and/or arm tracking in 3D. Both static and dynamic gestures (e.g., examples in FIG. 5) may be detected and recognized by the gesture recognition module 201. A recognized static gesture may be a hand sign formed by moving the fingers, wrist, and other components of the hand into a pre-defined configuration (e.g., position and orientation) defined in the gesture library within certain tolerance (e.g., the configuration may be within an acceptable pre-determined range), captured as a snap-shot of the hand at a given moment in time. The coordinates of points in the skeletal model (FIG. 33) of the hand and/or the relatively position of the tracked points may be compared against a set of acceptable ranges and/or a reference (e.g., a template) hand model of the particular gesture (stored in the gesture library) to determine whether a valid gesture has been positively detected and recognized. The tolerance may be an allowable amount of the joint positional and rotary coordinates of current hand compared with the acceptable reference coordinates stored in the gesture library.

The gesture recognition module 201 may use the methods described in U.S. Pat. No. 9,323,338 B2, to capture the hand gestures and recognize the hand gestures.

In some embodiments, a dynamic gesture may be a sequence of recognized hand signs moving in a pre-defined trajectory and speed within certain tolerance (e.g., a pre-determined range of acceptable trajectories, a pre-determined range of acceptable values of speed). The position, movement and speed of the hand may be tracked and compared against reference values and/or template models in the pre-defined gesture library to determine whether a valid gesture has been positively detected. Both conventional computer vision algorithm and deep learning-based neural networks (applied stand-alone or in combination) may be used to track and recognize static or dynamic gestures.

Once a valid gesture is detected (and together with other possible non-gesture user input), the mode determination module 202 may search for a trigger event that triggers a full-access gesture tracking mode. For example, a trigger event may be a captured hand gesture by a camera, a voice captured by a sound sensor, or a push of a physical button equipped on the automobile. In some embodiments, the full-access gesture tracking mode may be triggered by a combination of two or more of the captured events. For example, when the mode determination module 202 receives from sensors a hand gesture and a voice, the mode determination module 202 may determine to trigger a full-access gesture tracking mode.

The quick-access control module 204 may be configured to enable interactions controlled by quick-access gestures. A quick-access gesture may be defined as a gesture used to control the components of the automobile without triggering the full-access gesture mode. For example, without triggering the full-access gesture tracking mode, the quick-access gesture control module 204 may detect a user's hand gesture (e.g., waving the hand with five fingers extending) and control the rolling up and down of the window. In another example, the quick-access control module 204 may detect a combination of a hand gesture and a voice (e.g., detecting a voice command to quickly launch climate control app and detecting hand gestures to fine tune temperature settings) and control the automobile to perform a pre-defined function (e.g., launching climate control app, tuning temperature settings, etc.).

In some embodiments, the quick-access control module 204 may also be configured to work even when the full-access gesture tracking mode is turned on. For example, the quick-access control module 204 may detect a quick-access gesture and control the corresponding function of the car while the full-access gesture tracking mode is on and the full-access gesture tracking module 206 may be actively working.

The quick-access module 204 and full-access module 206 may receive valid gestures, static or dynamic, detected and recognized by the gesture recognition module 201 and perform the appropriate actions corresponding to the recognized gestures. For example, the quick-access module 204 may receive a gesture to turn up the radio and then send a signal to the radio control module to change the volume. In another example, the full-access module 206 may receive a gesture to activate the navigation application and then send a signal to the host processor 116 to execute the application and bring up the GUI of the navigation application on the screen 114.

In summary, with the pre-defined hand gestures and corresponding functions, the gesture control module 110 may receive data from the sensor modules 112 and identify a hand gesture. The gesture recognition module 201 may use the methods described in U.S. Pat. No. 9,323,338 B2, to capture the hand gestures and recognize the hand gestures. The gesture modules 204 and 206 may then trigger a function (e.g., an application such as temperature control app) of the infotainment system by sending a signal or an instruction to the infotainment system controlled by the host processor 116. In some embodiments, the gesture modules 204 and 206 may also detect a hand gesture that is used to switch between functions. The gesture modules 204 and 206 may send an instruction to the infotainment system to switch the current function to a new function indicated by the hand gesture.

Other types of actions may be controlled by the gesture modules 204 and 206 based on hand gestures. For example, the gesture modules 204 and 206 may manage the active/inactive status of the apps, display and hide functions, increase or decrease a quantity (such as volume, temperature level), call out a menu, cancel a function, etc. One skilled in the art may appreciate other actions that may be controlled by the gesture modules 204 and 206.

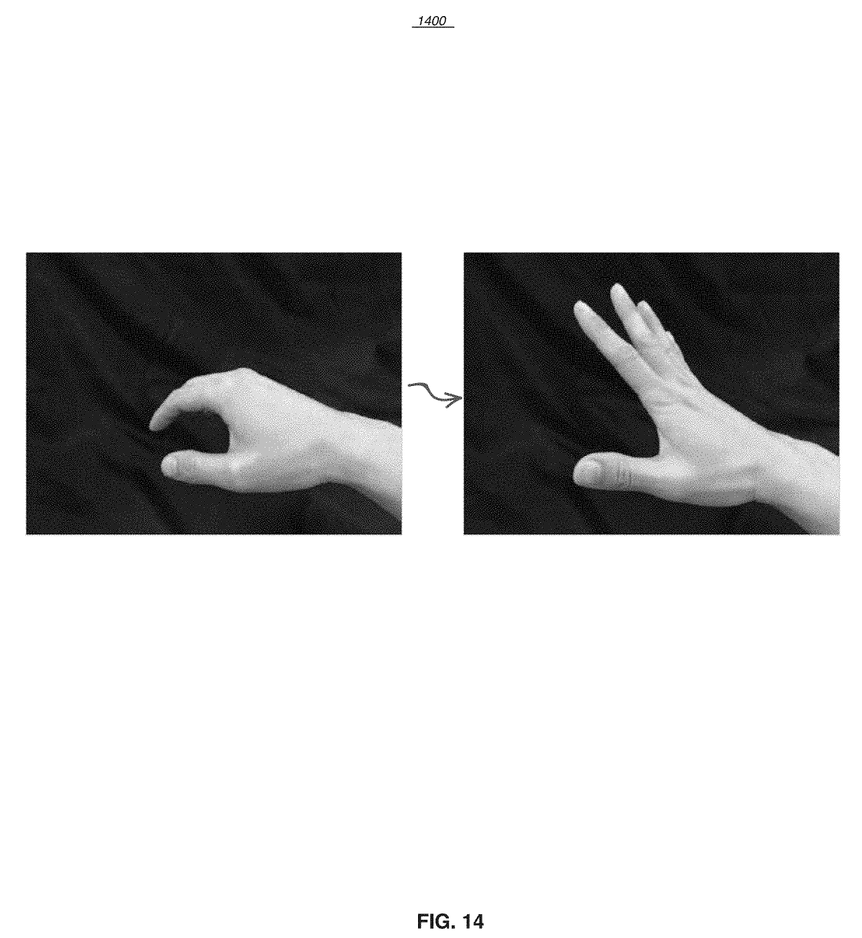

Referring to FIG. 5, illustrated is a flow diagram 500 showing hand gesture identification and corresponding actions according to an exemplary embodiment. A hand gesture identification (block 502) may be performed by the full-access gesture module 206 or the quick-access module 204. The hand gesture identification module (block 502) may recognize a set of gestures based on user's hand action. And after a gesture is recognized, a specific system action may be triggered. FIG. 5 illustrates an example of a set of gestures which may be recognized by the hand gesture identification module (block 502), and examples of specific system actions triggered for each of the gestures. If the hand gesture is five fingers swiping up (block 504A), the full-access gesture tracking mode may be triggered (block 506A). Referring to FIG. 14, a graph 1400 showing a hand gesture of five fingers swiping up to turn on full-access gesture tracking is illustrated according to an exemplary embodiment.

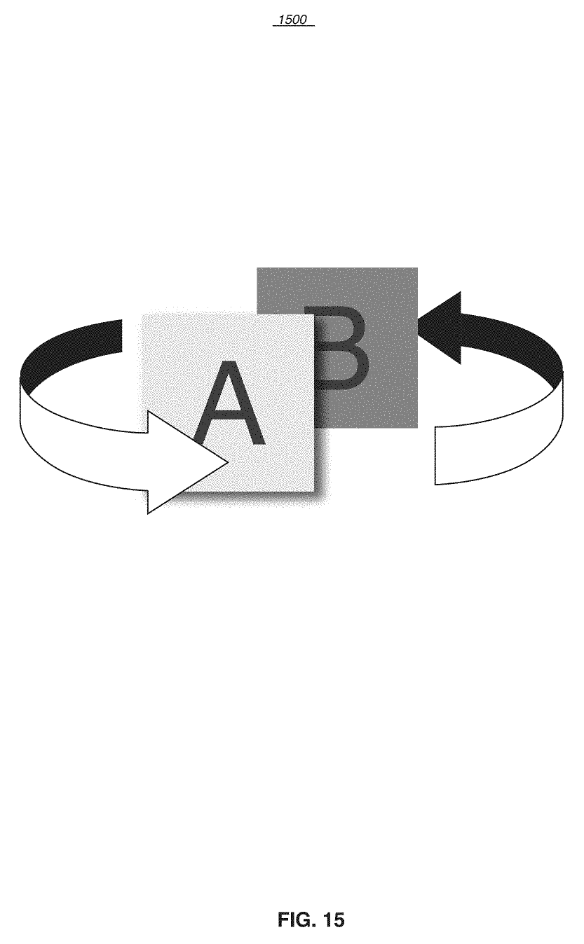

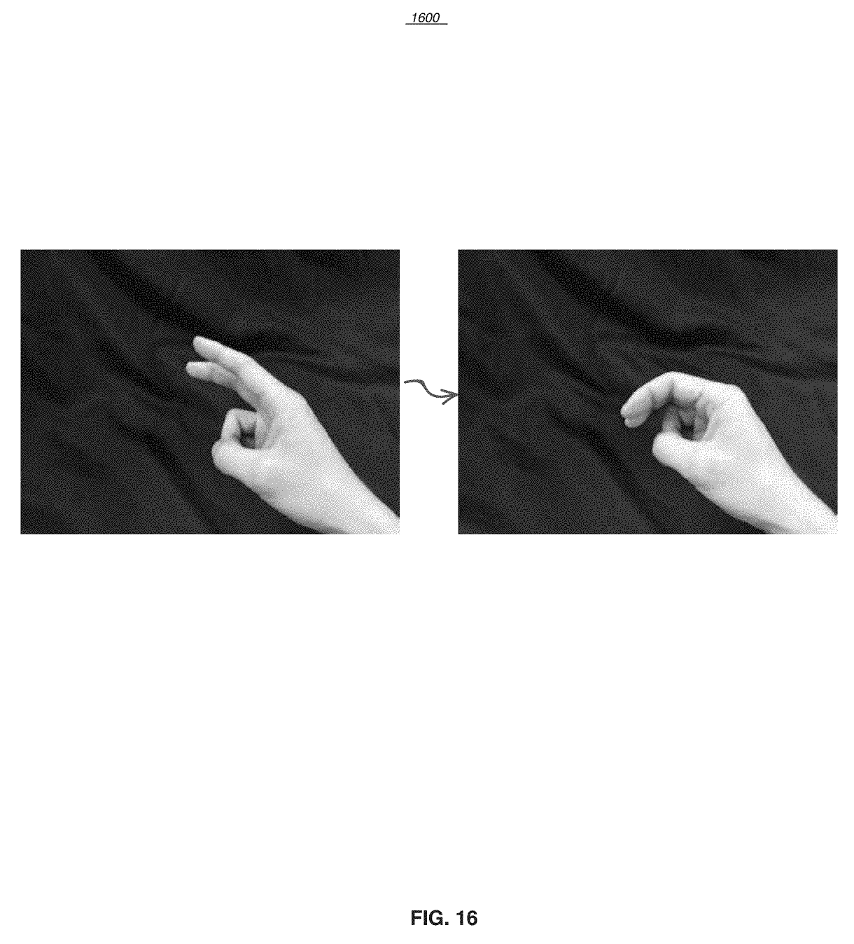

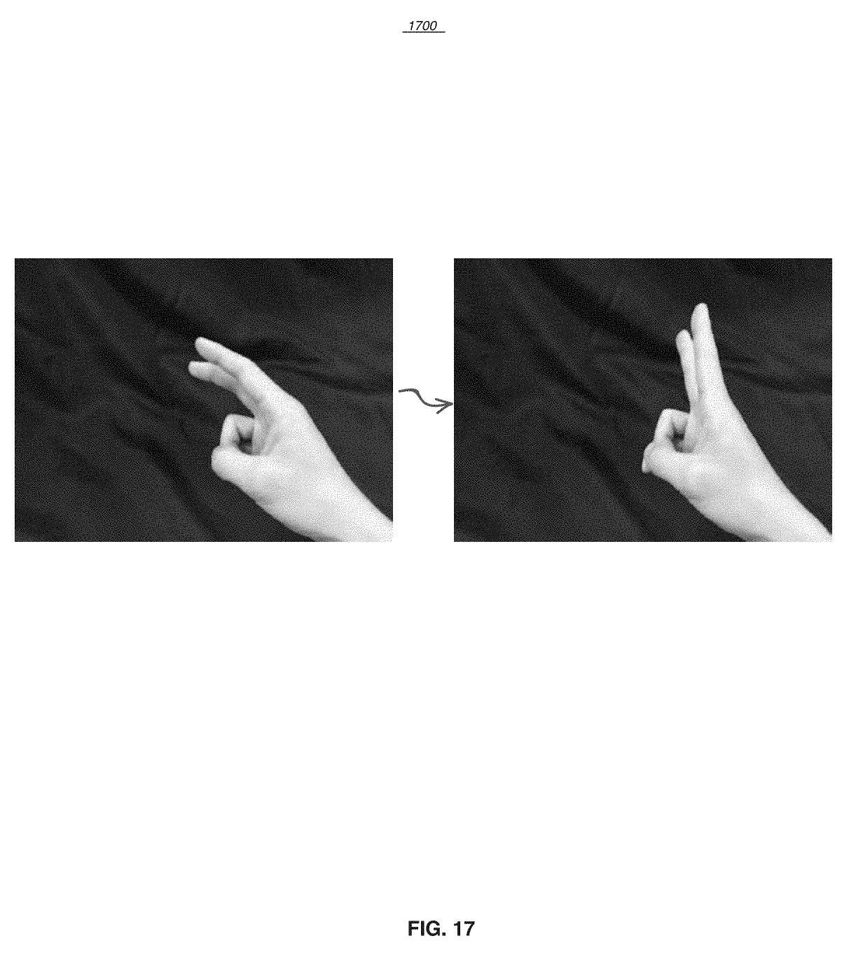

If the hand gesture is two fingers swiping (block 504B), e.g., swiping left or right, functions may be switched between each other (block 506B). Referring to FIG. 15, switching between functions is shown according to an exemplary embodiment. Block A represents function A, and block B represents function B. Function A and function B may be apps of the infotainment system. Function A and function B may be switched between each other. The system 102 may enable a user to use such hand gesture to toggle between function A and function B. The GUI may show the switching of function A and function B from foreground to background and vice versa, respectively. After switching, the foreground function may be performed while the background function may be paused, inactivated, hidden, or turned off. Referring to FIGS. 16 and 17, graphs 1600 and 1700, a hand gesture of two fingers swiping left and right to switch functions are illustrated respectively.

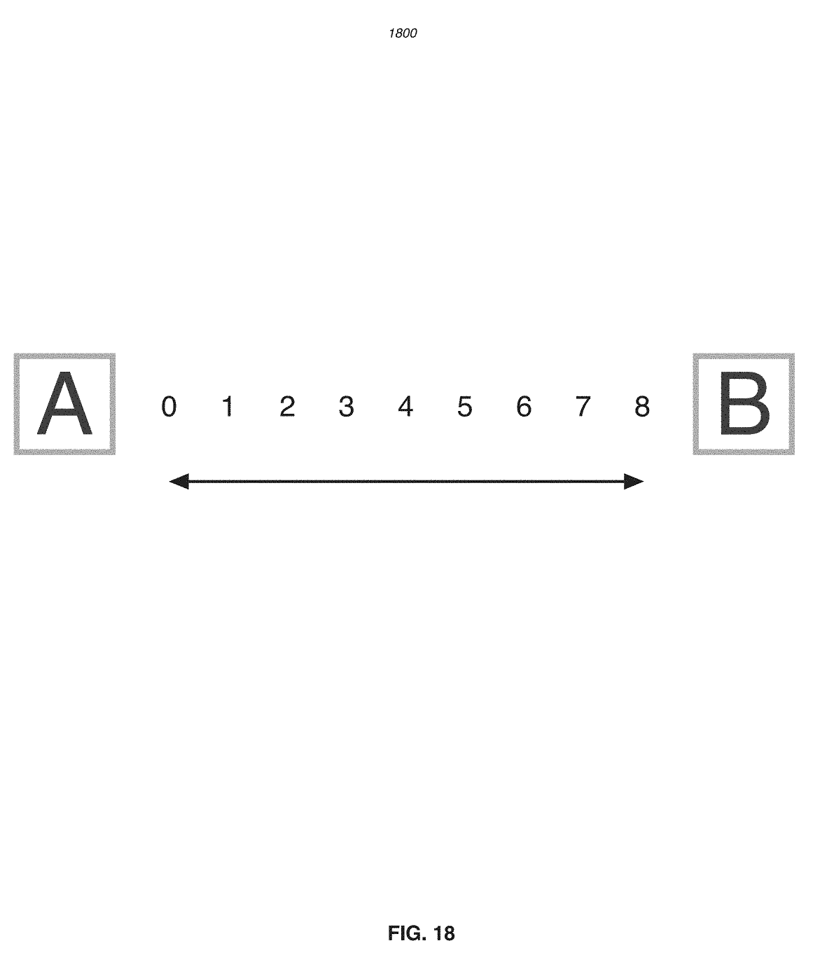

If the hand gesture is two fingers swiping and holding (block 504C), moving and selecting a quantity may be performed (block 506C). Referring to FIG. 18, a move and selection of a quantity is shown according to an exemplary embodiment. For example, in a temperature adjustment scenario, A may represent an inactive status of the air conditioner (e.g., the fan is off), B may represent an active status of the air conditioner (e.g., the fan is on the highest speed). The number 0-8 may represent the speed of a fan, where zero may be the lowest, and eight may be the highest speed. The movement of two fingers may be used to select a quantity on a sliding scale between two extreme settings A and B.

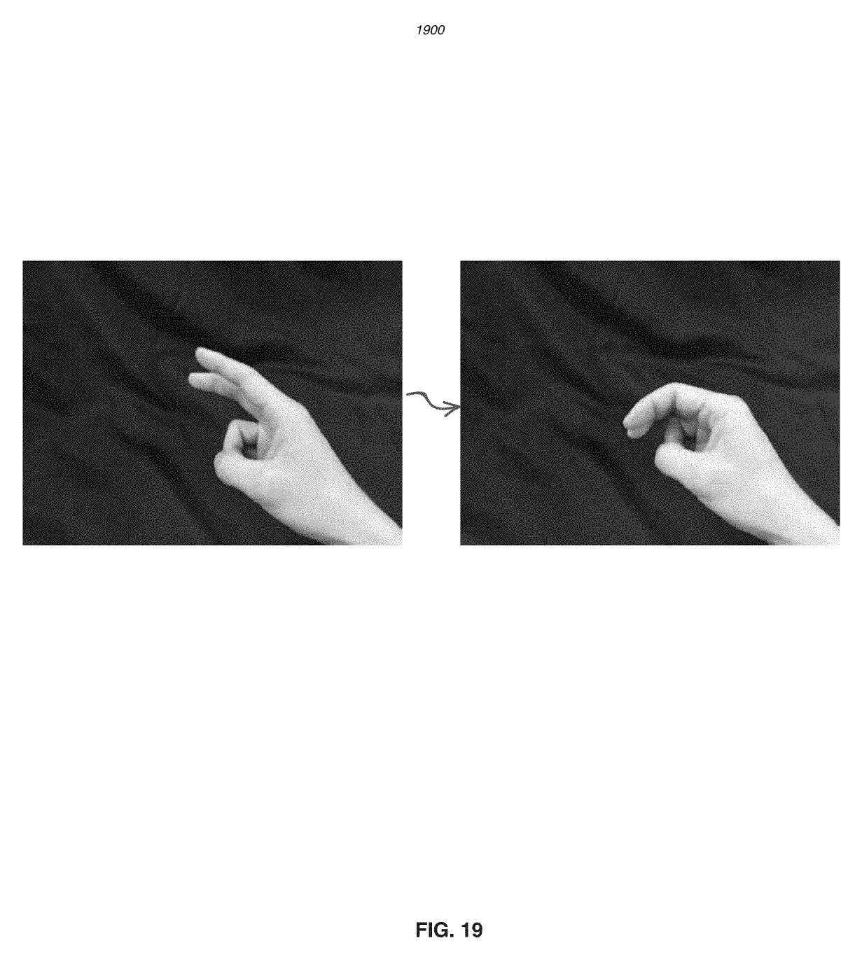

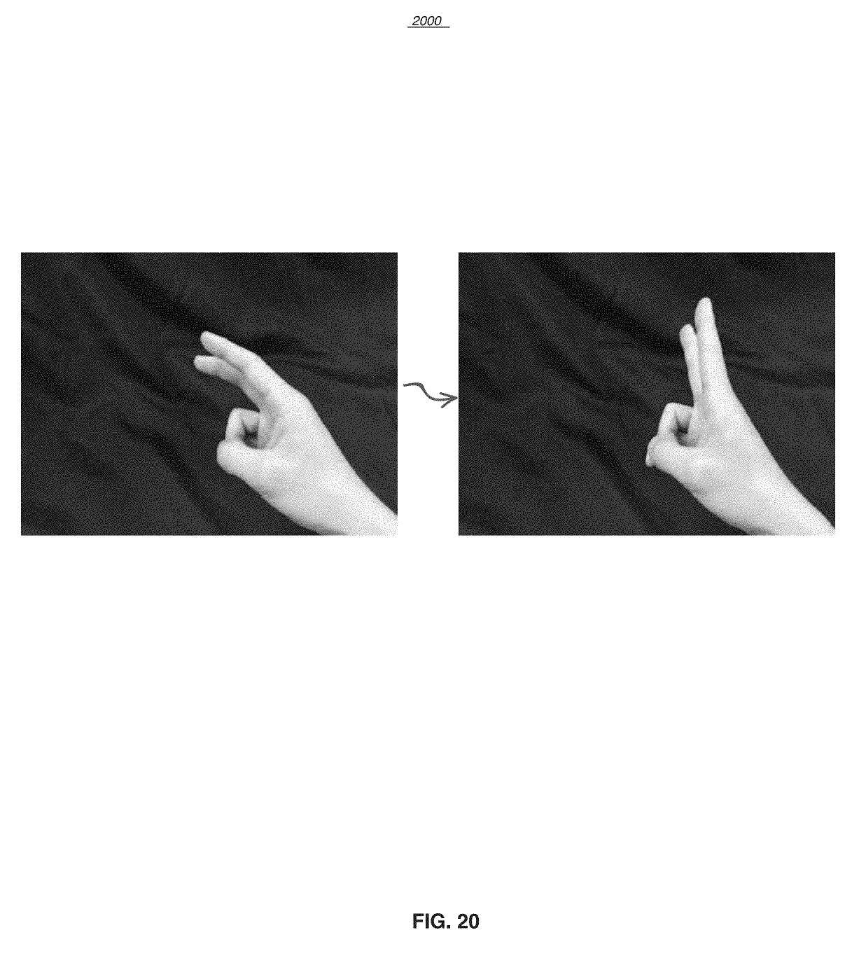

Referring to FIGS. 19 and 20, graphs 1900 and 2000 show a hand gesture of two fingers swiping left and holding, and a hand gesture of two fingers swiping right and holding, to decrease or increase the quantity, respectively, according to an exemplary embodiment. In the above temperature adjustment scenario, if a cursor on the display following the two fingers is on the number 4 position of FIG. 18, then two fingers swiping left and holding at a later position may cause the cursor to move to the left and stop at a number such as 3, 2, 1, 0, etc. Similarly, two fingers swiping right and holding at a later position may cause the cursor to move to the right and stop at a higher number such as 5, 6, 7, 8, etc.

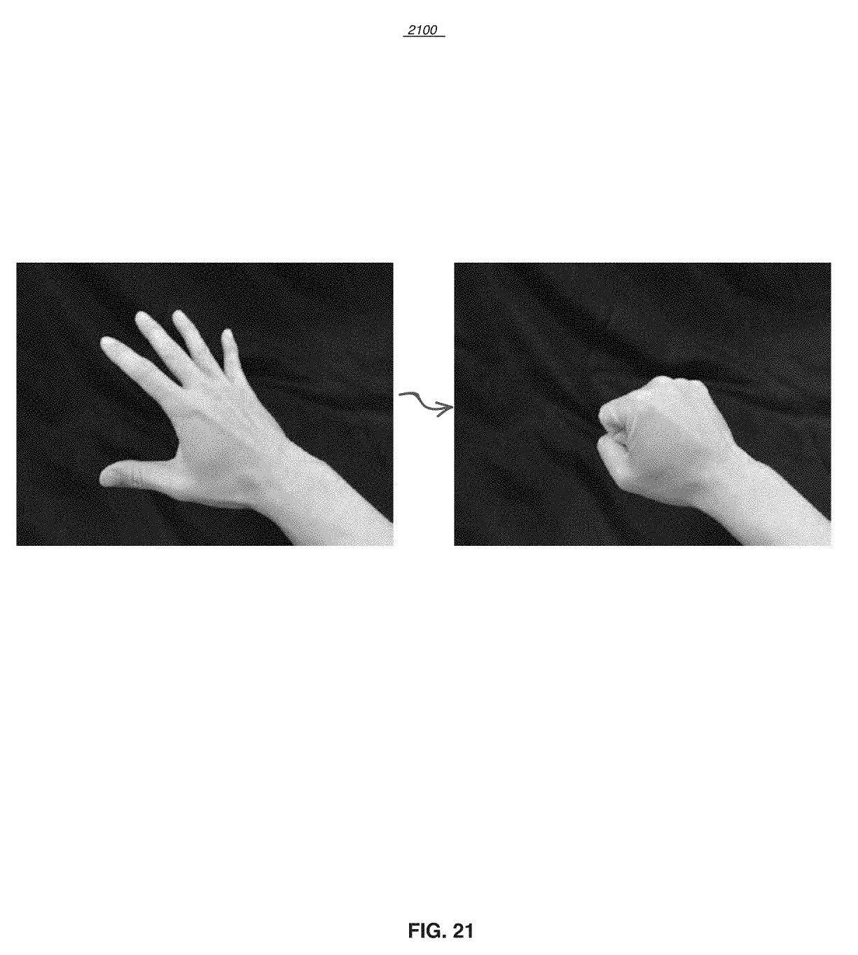

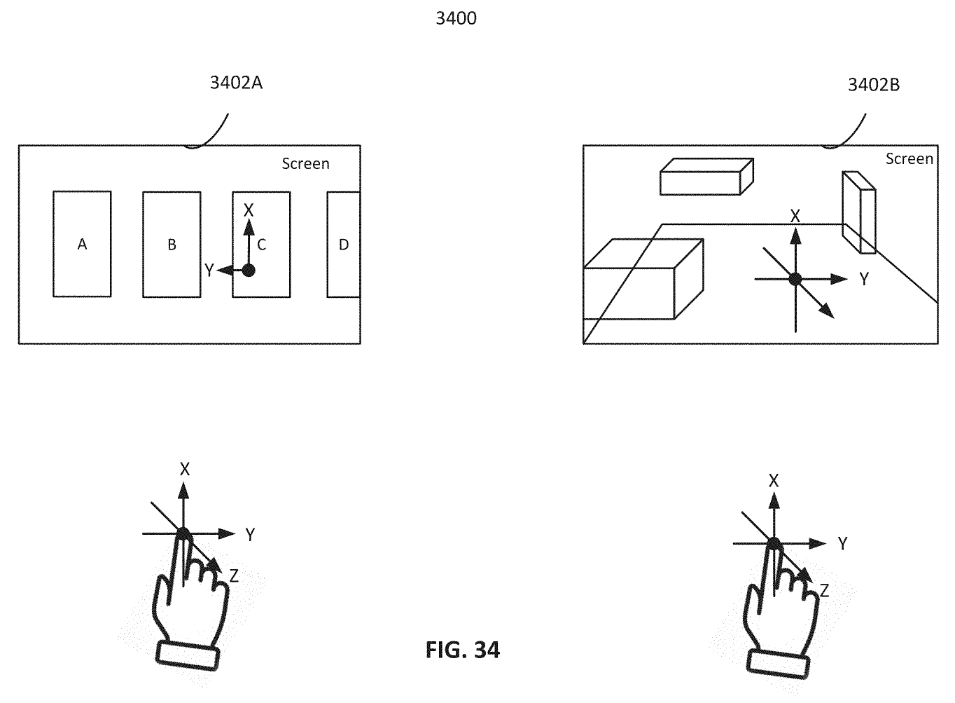

Referring back to FIG. 5, if the hand gesture is making a fist (block 504D), e.g., changing palm to a fist and holding, then three dimensional (3D) movement and detection may be enabled (block 506D). Referring to FIG. 21, illustrated is a graph 2100 showing a hand gesture of a palm facing down with all fingers extended first then closed up to make a fist, enabling control of a 3D GUI as illustrated in FIG. 34 according to an exemplary embodiment. In FIG. 34, in a 2D GUI, the hand movement in the Z direction is ignored. In a 3D GUI, the movement of the hand along X,Y,Z axes corresponds to the cursor movement along X,Y,Z axes in the 3D GUI display.

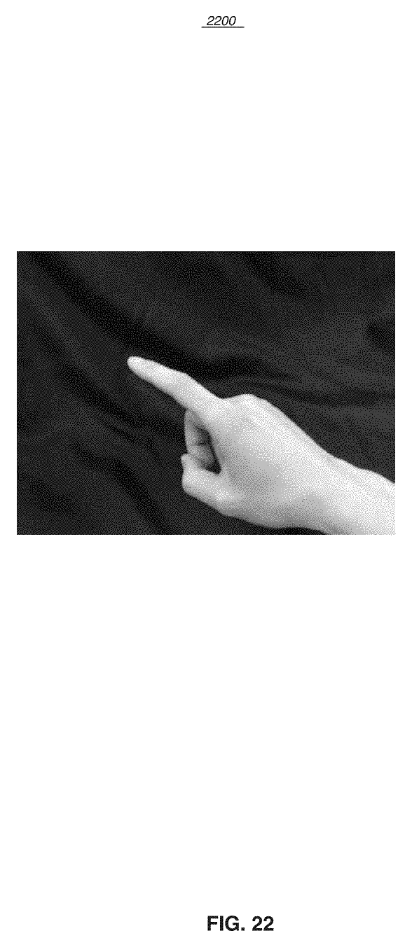

If the hand gesture is one finger pointing and holding (block 504E), a selection may be performed (block 506E). For example, in a menu displayed on the screen of the infotainment system, there may be several function buttons or items (icons). The hand gesture of one finger pointing at a position corresponding to one button or item (icon) and holding at the position may trigger the selection of the button or item (icon). In some embodiments, the button or item (icon) may only change in appearance (e.g., highlighted) and may not be clicked and activated by the above-describe hand gesture unless another gesture (or other user input) is made to activate it. Referring to FIG. 22, a graph 2200 is to show a hand gesture of a finger pointing and holding to select a function according to an exemplary embodiment.

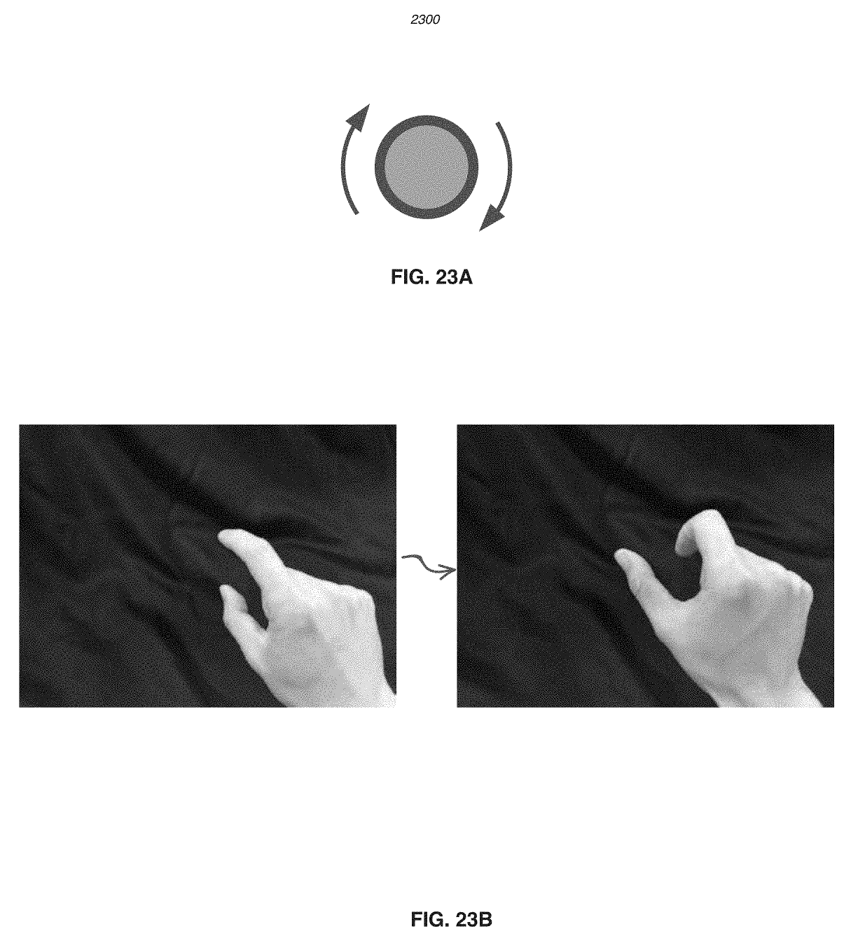

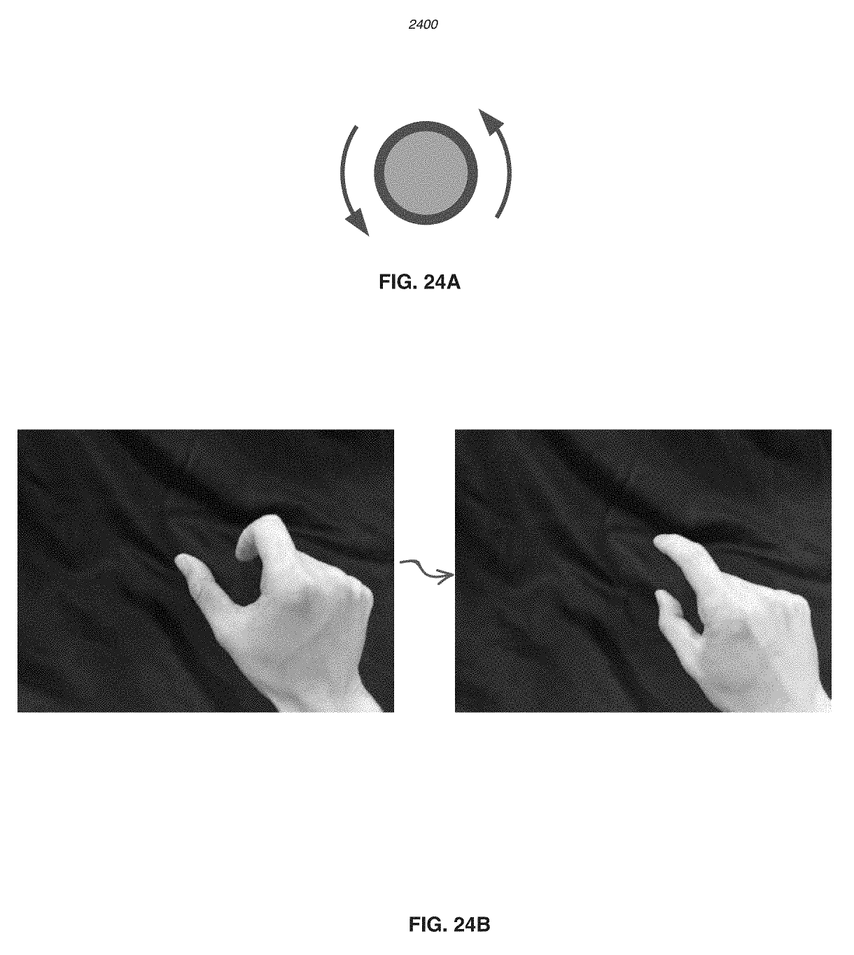

If the hand gesture is two fingers extending and rotating (block 504F), increasing or decreasing of a quantity may be performed (block 506F). Referring to FIG. 23A, a clockwise rotation is shown according to an exemplary embodiment. Referring to FIG. 23B, a graph 2300 shows a hand gesture of two fingers extending and rotating clockwise to increase a quantity according to an exemplary embodiment. For example, a hand gesture of two fingers extending and rotating clockwise is to increase the volume of music or radio. Referring to FIG. 24A, a counter-clockwise rotation is shown according to an exemplary embodiment. Referring to FIG. 24B, a graph 2400 shows a hand gesture of two fingers extending and rotating counter-clockwise to decrease a quantity according to an exemplary embodiment. For example, a hand gesture of two fingers extending and rotating counter clockwise is to decrease the volume of music or radio.

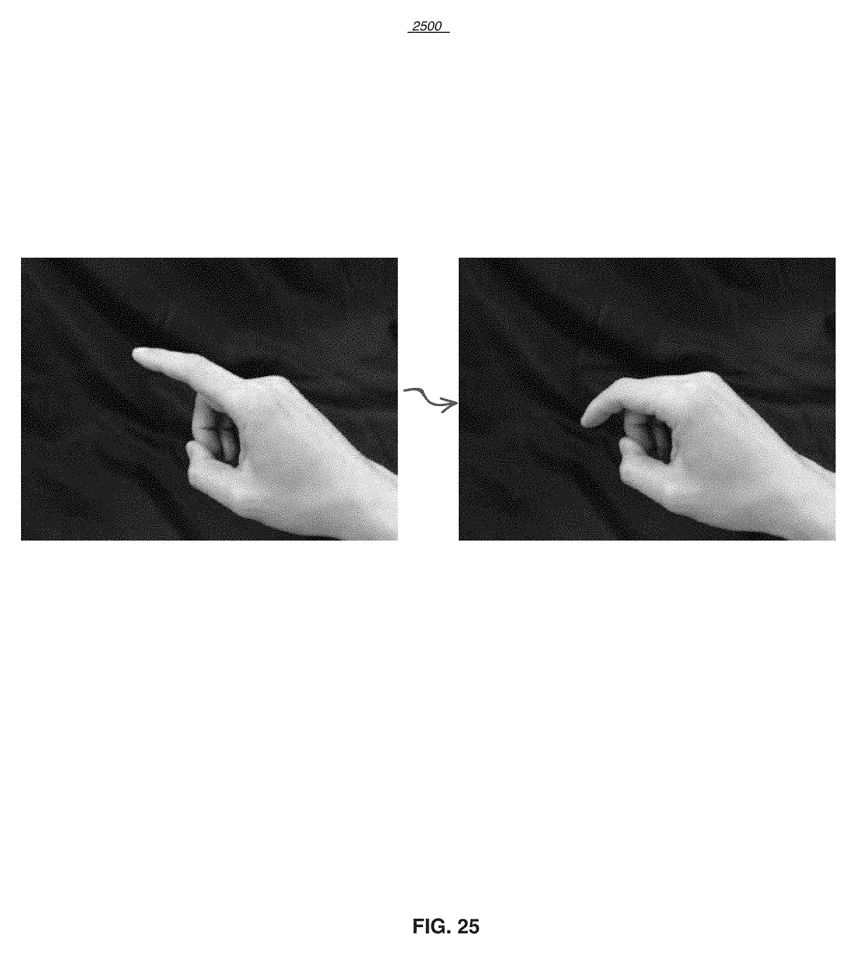

If the hand gesture is one finger tapping (block 504G), a clicking or activation may be performed (block 506G). For example, after a function button or item (icon) is selected based on a hand gesture defined by block 504E, a hand gesture of the finger tapping may cause the clicking of the function button or item (icon). The function button or item (icon) may be activated. Referring to FIG. 25, a graph 2500 shows a hand gesture of one finger tapping to click or activate a function according to an exemplary embodiment.

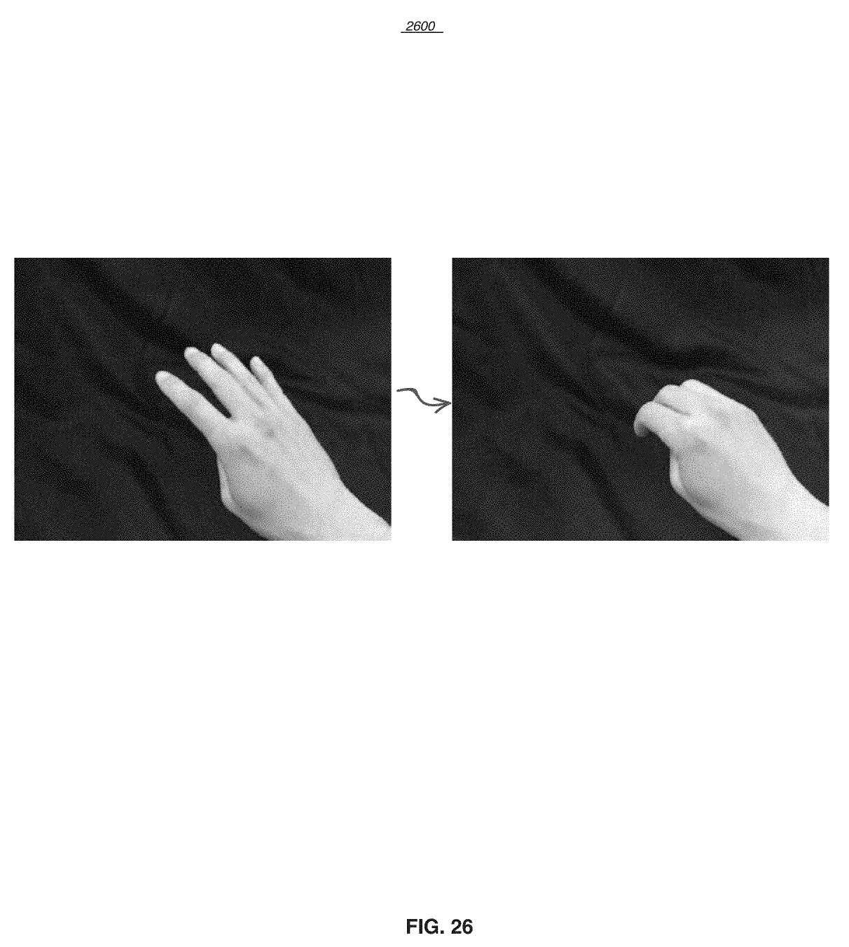

If the hand gesture is four fingers tapping (block 504H), canceling a function may be performed (block 506H). Referring to FIG. 26, a graph 2600 shows a hand gesture of four fingers tapping to cancel a function according to an exemplary embodiment.

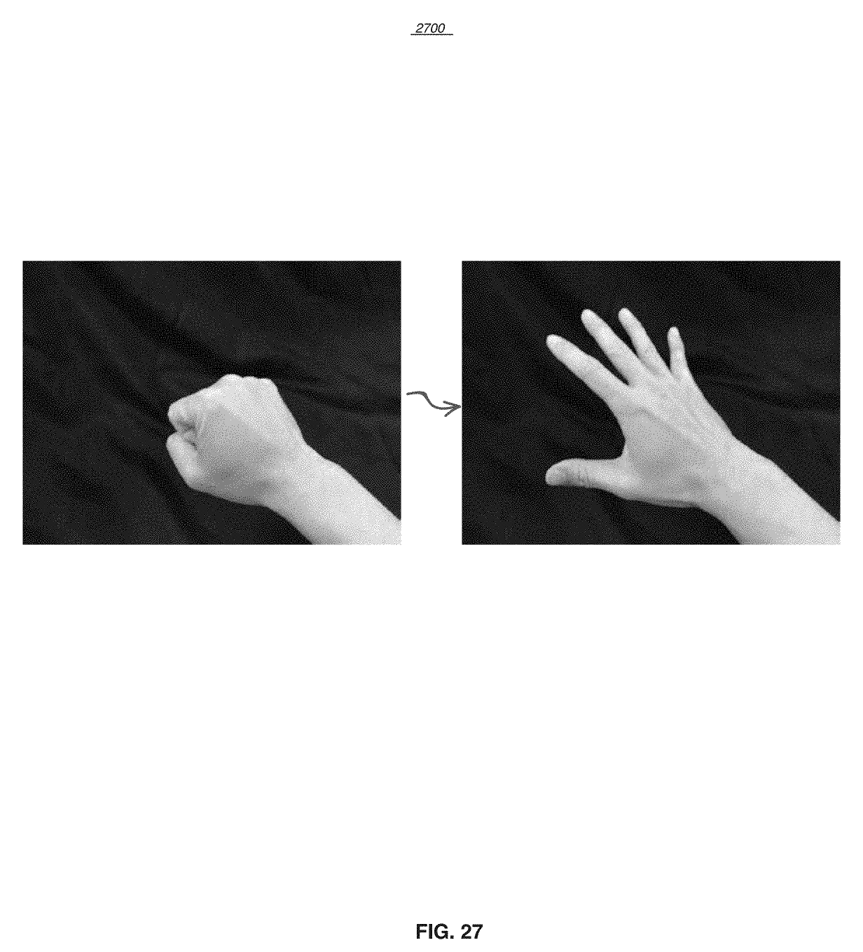

If the hand gesture is changing from a fist to a palm (block 504I), disengaging the full-access gesture tracking mode is performed (block 506I). Referring to FIG. 27, illustrated is a graph 2700 showing a hand gesture of changing from a fist to a palm to disengage full-access gesture tracking according to an exemplary embodiment.

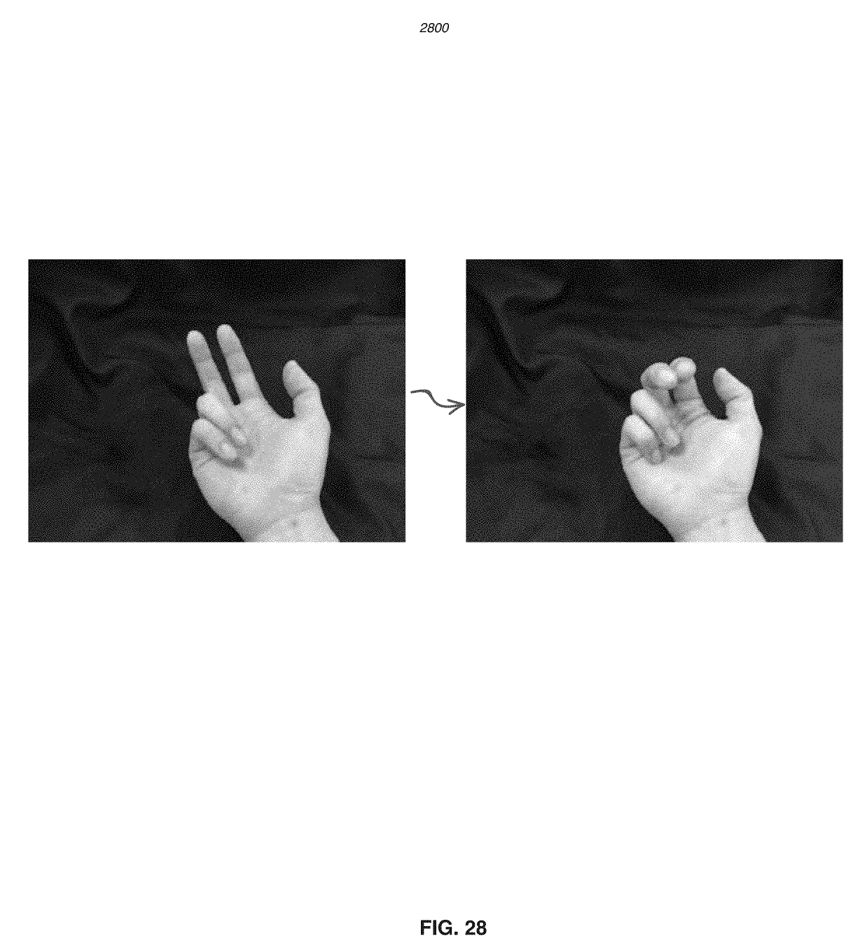

If the hand gesture is rolling up two fingers (block 504J), e.g., palm up and rolling up two fingers, then a callout of a menu may be performed (block 506J). Referring to FIG. 28, illustrated is a graph 2800 showing a hand gesture of palm up and then rolling up two fingers to call out a menu according to an exemplary embodiment.

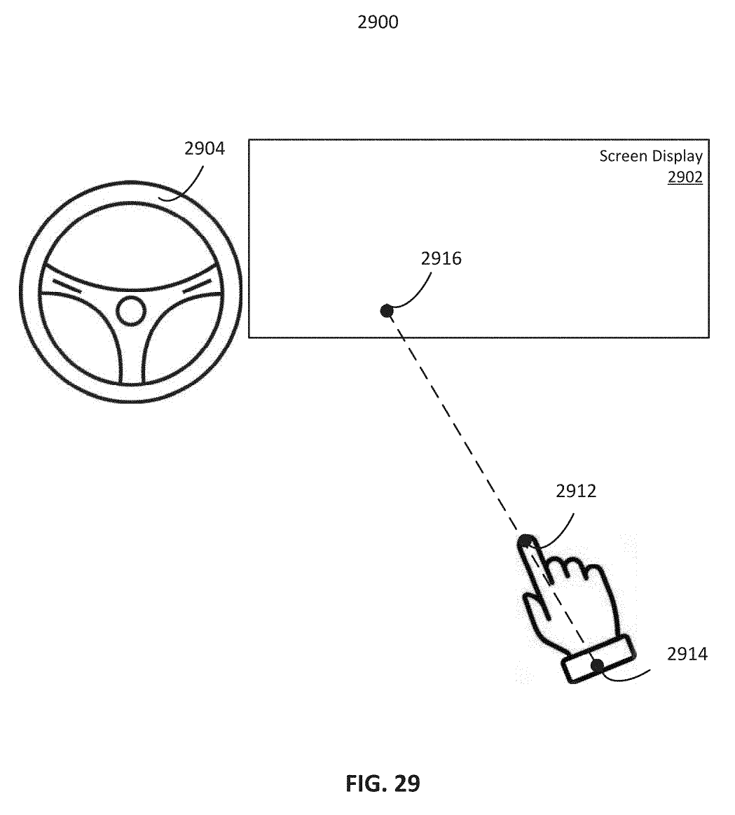

Referring back to FIG. 2, the gesture recognition module 201 may use the method described in U.S. Pat. No. 9,323,338 B2, to detect, track and compute the 3D coordinates of multiple points of a hand (e.g., finger tips, palm, wrist, joints, etc.), as illustrated in FIG. 29. Referring to FIG. 29, schematically illustrated is an interaction controlled under a cursor mode according to an exemplary embodiment. A line connecting any two points forms a vector. For example, a line connecting the tip of an extended finger and the center of the wrist forms a vector pointing towards the screen. By extending the vector beyond the fingertip, the trajectory of the vector will eventually intersect the surface of the display screen. By placing a cursor at the intersection and tracking the position of the hand, the position of the cursor may be changed by the corresponding movement of the hand. As illustrated in FIG. 29, the wrist becomes a pivot and the displacement of the vector (formed between the fingertip and wrist) is magnified by the distance between the fingertip and the screen, thus traversing a large screen area through small movement of the hand.

In some embodiments, the elbow may be used as the pivot and the vector formed between the fingertip and the elbow may be used to navigate the screen. The elbow-finger combination allows an even larger range of movement on the screen. Pivot points may rest on a support surface such as arm rest or center console to improve stability and reduce fatigue. The full-access gesture module 206 may control the display of the cursor's position and rotation on the screen based on the hand position and rotation (e.g., finger tip's position and rotation, wrist's position and rotation in the real world space).

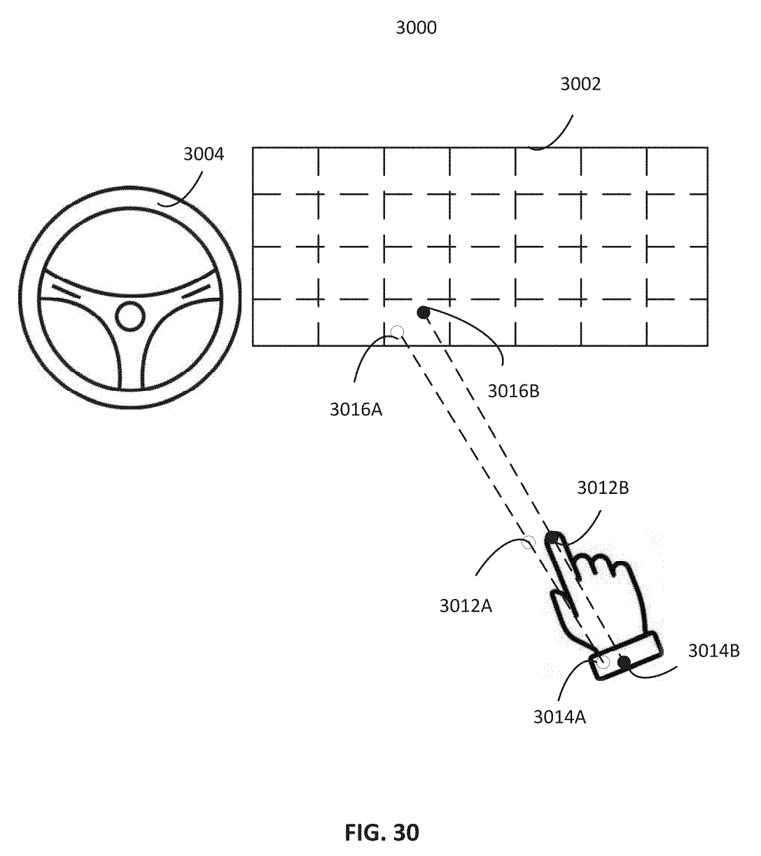

In some embodiments, the elbow is also recognized and tracked by the system in addition to the hand, offering additional degrees of freedom associated with major joints in the anatomy of the hand and elbow, as illustrated in FIG. 33. FIG. 33 shows the tracking of critical points on a hand with one or more degrees of freedom to form a skeletal model according to an exemplary embodiment. Any two points may be used to form a vector for navigation on the screen. A point may be any joints in FIG. 33. A point may also be formed by the weighted average or centroid of multiple joints to increase stability. The movement of the vector along the X and Z axis (as in the hand orientation in FIG. 30) translates into cursor movement in the respective axis on the screen. The movement of other parts of elbow or hand that are not part of the vector may be used to make gestures for engaging cursor, releasing cursor, selection (a “click” equivalence), etc. Examples for such gestures may include, but are not limited to, touching one finger with another finger, extending or closing fingers, moving along the Y axis, circular motion, etc.

In some embodiments, it is possible to navigate the cursor and make other gestures at the same time. For example, the system 102 allows touching the tip or middle joints of the middle finger with the thumb to gesture cursor engagement, cursor release, or selection, etc., while performing cursor navigation and pointing in response to detecting and recognizing the gesture of extending the index finger. One skilled in the art should appreciate that many other combinations are also enabled by the system 102.

In some embodiments, the granularity of the movement may be a block or a grid on the screen. Referring to FIG. 30, schematically illustrated is an interaction controlled under a grid mode according to an exemplary embodiment. Similar to the cursor mode, in grid mode, the full-access gesture module 206 may use the position and rotation of hand to control the selection of icons placed on a grid. For example, based on the position and rotation of the fingertip and the wrist, the full-access gesture tracking module 206 may control the infotainment system to select an icon (e.g., by highlighting it, etc.). Therefore, instead of using a small cursor (albeit a more precise pointing mechanism), the full-access gesture tracking module 206 may configure the infotainment system to use a larger indicator (e.g., placing icons on a pre-defined and well-spaced grid formed by a combination of a pre-determined number of vertically or horizontally lines) to give the user a better visual feedback which is more legible when the user is sitting back on the driver's or passenger's seat.

In some embodiments, the grid lines may or may not be uniformly, equally or evenly spaced. A well-spaced grid provides ample space between icons to minimize false selection when the user hand is unstable. For example, a well-spaced grid may be a vertical and/or horizontal divided space usually is larger than the icon size according to the given screen size. In one example, the neighboring four grids may also be combined into a larger grid. In another example, the screen may be divided into a pre-determined number of blocks or regions, e.g., three blocks or regions, four blocks or regions, etc. When the hand's position corresponds to a position in one block or region, the whole block or region is selected and highlighted.

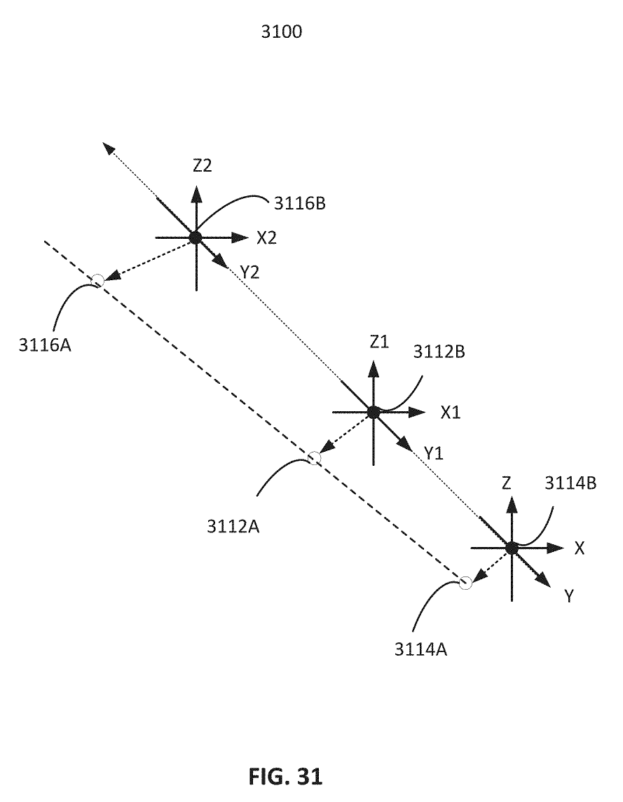

In addition, the grid mode may facilitate the robust interaction even when the driving condition is unstable. Referring to FIG. 31, schematically illustrated is an algorithm 3100 controlling screen navigation according to an exemplary embodiment. In some embodiments, the algorithm 3100 may be used to control the interaction under the grid mode. For example, in the algorithm 3100, a last video frame may be captured and stored describing a position and rotation of the hand (e.g., position and rotation of a fingertip, position and rotation of a wrist) at a last time point. A position and rotation of the indicator on the screen display at the last time may also be stored. The coordinates may be used and stored to represent the position and rotation of the fingertip, the wrist, and the indicator.

The full-access gesture module 206 may detect the current position and rotation of the hand at the current time point. The position and rotation of the wrist and fingertip at the current time may be represented by coordinates (x, y, z) and (x1, y1, z1), respectively. A position and rotation of the indicator on the screen display at the current time point may be represented by coordinate (x2, y2, z2). The last position and rotation may be compared with the current position and rotation by utilizing the coordinates. Movement of the position and rotation may be represented by A (for wrist), A1 (for fingertip) and A2 (for indicator). If the movement between the last and current position and rotation is less than a pre-defined range (e.g., 0.1-3 mm), then the full-access gesture module 206 may control the infotainment system to display the indicator at the same position as the last time point. That is, if the coordinate movement of wrist and fingertip (A, A1) is within the pre-defined range, the coordinate movement of the screen indicator (A2) may remain in the selected area. For example, the icon selected last time may still be selected, instead of another icon (such as an adjacent one) being selected.

The benefit of allowing such a pre-defined range of difference (or change) of the position and rotation of the hand is to accommodate a certain level of instability of driving. While driving under bad road condition, the user's hand may be inadvertently shaken to move or rotate slightly, thus creating false motion. Without the allowance of slight drift, hand movement jitters may trigger the infotainment system to display or perform some functions not intended by the user. Another benefit is to allow gesturing while the icon remains highlighted as long as the gesture motion doesn't cause the hand to move outside of the current grid.

By using the three coordinate systems to capture the fingertip's position and rotation, the wrist's position and rotation, and the corresponding position and rotation of the point on the screen display, an interaction with visual feedback may be achieved. By filtering the undesired small movement or rotation, a robust interaction based on hand position, rotation and gestures may be accomplished.

In some embodiments, one or more sensor modules 112 may measure the instability level of the driving and use the stability data to dynamically adjust the pre-defined allowance range. For example, when the instability level is higher, the gesture tracking module 206 may reduce the sensitivity of motion detection even if the difference between fingertip's position and rotation in the last frame and those in the current frame and/or the difference between the wrist's position and rotation in the last frame and those in the current frame are relatively larger. On the other hand, if the condition is relatively stable, then the full-access gesture module 206 may increase the sensitivity. In some embodiments, the full-access gesture module 206 may allow the cursor mode only when the driving condition is stable or when the vehicle is stationary. In some embodiments, the GUI of the screen may change in response to driving conditions (e.g., switching from cursor mode to grid mode in unstable driving condition).

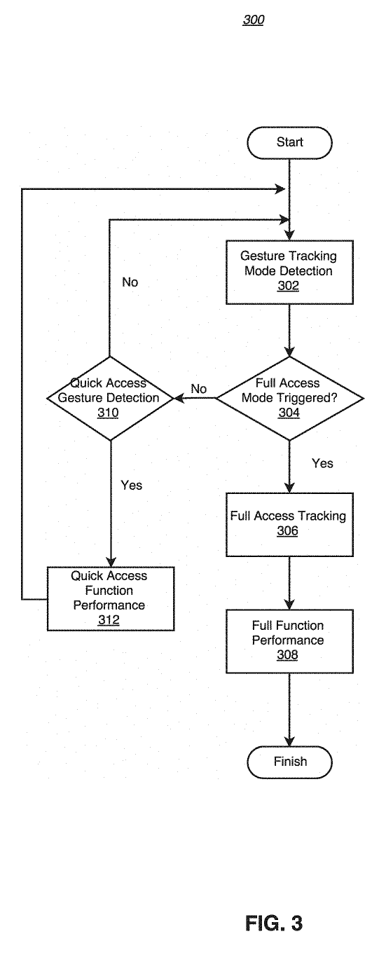

FIG. 3 is a flow diagram 300 showing an interaction process based on gesture control according to an exemplary embodiment. The process may start with gesture tracking mode detection (block 302). It may then determine whether a full-access gesture tracking mode has been triggered (block 304). If the full-access gesture tracking mode is not triggered, then the process may perform quick access gesture detection (block 310) and perform quick access functions (block 312). Quick access functions may be a subset of the set of full functions available in the full-access mode. In some embodiments, even if the full-access gesture tracking mode is activated (block 306), the user is still able to use several predefined quick-access gestures to perform quick-access functions. Functions controlled by quick-access gestures typically do not rely on or not heavily rely on screen display or visual feedback to the user. For example, quick access functions may be the volume control of a media application, and answering or rejecting calls function of a phone application, etc.

If the full-access gesture tracking mode is triggered, then the process 300 may perform full gesture control in the full-access gesture tracking mode, as described above with reference to FIG. 2. The system 102 may perform gesture tracking to track a complete set of hand gestures (block 306), such as those defined in FIG. 5. The process 300 may enable full function performance under the gesture tracking mode (block 308). For example, the system 102 may enable the user to open and close applications, switch between applications, and adjust parameters in each application by using different hand gestures as defined with reference to FIG. 5. Usually, the complete set of hand gestures in the full-access gesture tracking mode is a superset of quick-access gestures.

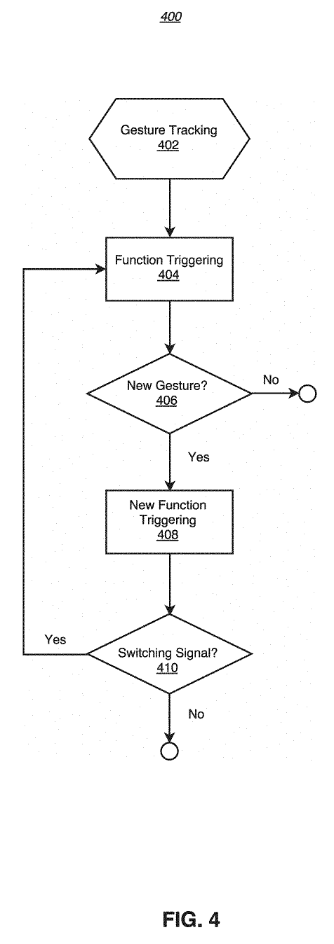

FIG. 4 is a flow diagram showing a process 400 of functions triggering and switching based on gesture tracking according to an exemplary embodiment. In some embodiments, the process 400 may be implemented by the full-access gesture module 206. The process 400 may start with gesture tracking (block 402). When a pre-defined hand gesture is detected, the process 400 may trigger a function indicted by the hand gesture (block 404). The process 400 may determine if a new gesture is detected (block 406). If so, the process 400 may trigger a new function indicated by the new gesture (block 408). The process 400 may determine if a switching signal is detected (block 410). For example, the switching signal may be a hand gesture, a voice, a push of a physical button, or a combination thereof.

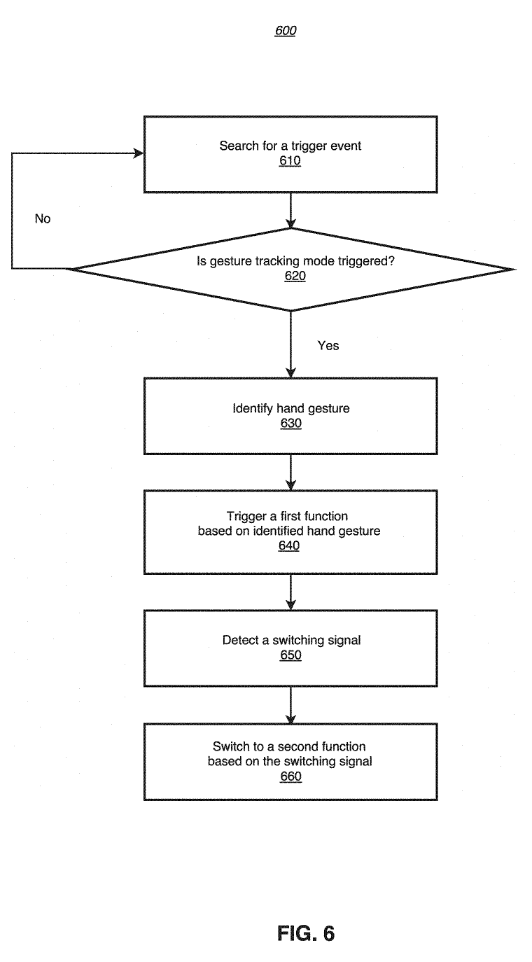

FIG. 6 is a flow chart showing an interaction process 600 based on gesture tracking according to an exemplary embodiment. In some embodiments, the process 600 may be implemented by the system 102. At block 610, a trigger event may be searched for. For example, a trigger event may be a hand gesture, a voice, a push of a physical button, or a combination thereof. At block 620, it may be determined whether a gesture tracking mode is triggered. At block 630, hand gestures may be identified. At block 640, a first function may be triggered based on the identified hand gesture. At block 650, a switching signal may be detected. At block 660, a second function may be switched to as a result of the switching signal.

FIG. 7 is a block diagram illustrating an example system 700 in which any of the embodiments described herein may be implemented. The system 700 includes a bus 702 or other communication mechanism for communicating information, one or more hardware processors 704 coupled with bus 702 for processing information. Hardware processor(s) 704 may be, for example, one or more general purpose microprocessors.

The system 700 also includes a main memory system 706, consisting of a hierarchy of memory devices such as dynamic and/or static random access memory (DRAM/SRAM), cache and/or other storage devices, coupled to bus 702 for storing data and instructions to be executed by processor(s) 704. Main memory 706 may also be used for storing temporary variables or other data during execution of instructions by processor(s) 704. Such instructions, when stored in storage media accessible to processor(s) 704, render system 700 into a special-purpose machine that is customized to perform the operations specified by the instructions in the software program.

Processor(s) 704 executes one or more sequences of one or more instructions contained in main memory 706. Such instructions may be read into main memory 706 from another storage medium, such as storage device 708. Execution of the sequences of instructions contained in main memory 706 causes processor(s) 704 to perform the operations specified by the instructions in the software program.

In some embodiments, the processor 704 of the system 700 may be implemented with hard-wired logic such as custom ASICs and/or programmable logic such as FPGAs. Hard-wired or programmable logic under firmware control may be used in place of or in combination with one or more programmable microprocessor(s) to render system 700 into a special-purpose machine that is customized to perform the operations programmed in the instructions in the software and/or firmware.

The system 700 also includes a communication interface 710 coupled to bus 702. Communication interface 710 provides a two-way data communication coupling to one or more network links that are connected to one or more networks. As another example, communication interface 710 may be a local area network (LAN) card to provide a data communication connection to a compatible LAN (or WAN component to communicate with a WAN). Wireless links may also be implemented.

The execution of certain operations may be distributed among multiple processors, not necessarily residing within a single machine, but deployed across a number of machines. In some example embodiments, the processors or processing engines may be located in a single geographic location (e.g., within a home environment, an office environment, or a server farm). In other example embodiments, the processors or processing engines may be distributed across a number of geographic locations.

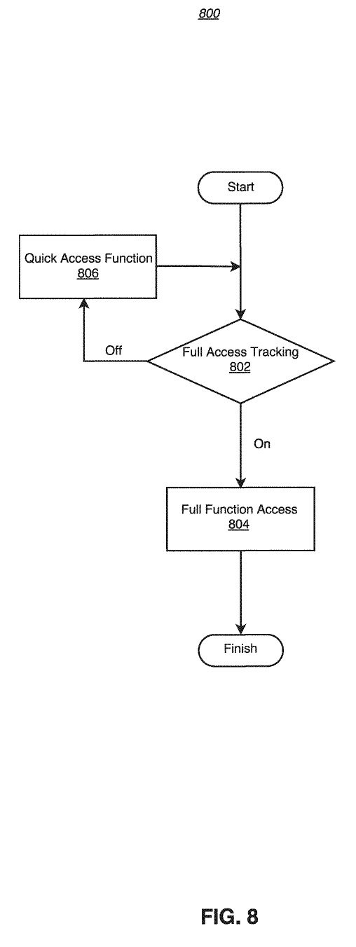

FIG. 8 is a flow diagram 800 showing interactions under two different modes according to an exemplary embodiment. The system 102 may detect whether the full-access gesture tracking mode is on or off (block 802). When the full-access gesture tracking mode is off, always-on quick-access gestures may be detected to quickly access certain functions (block 806). When the full-access gesture tracking mode is on, hand gestures may be detected to allow users fully access of functions of the infotainment system (block 804), e.g., to launch or close functions, and to switch between functions, etc.

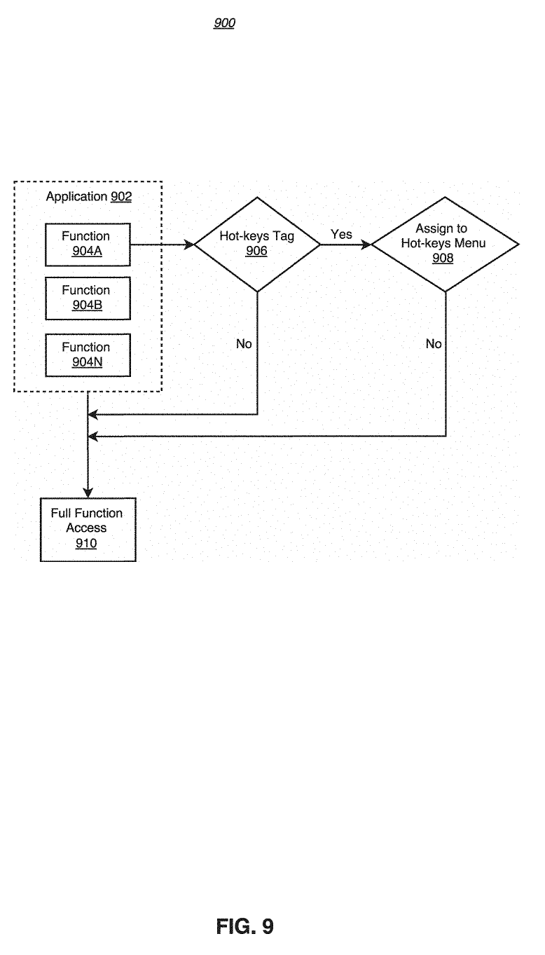

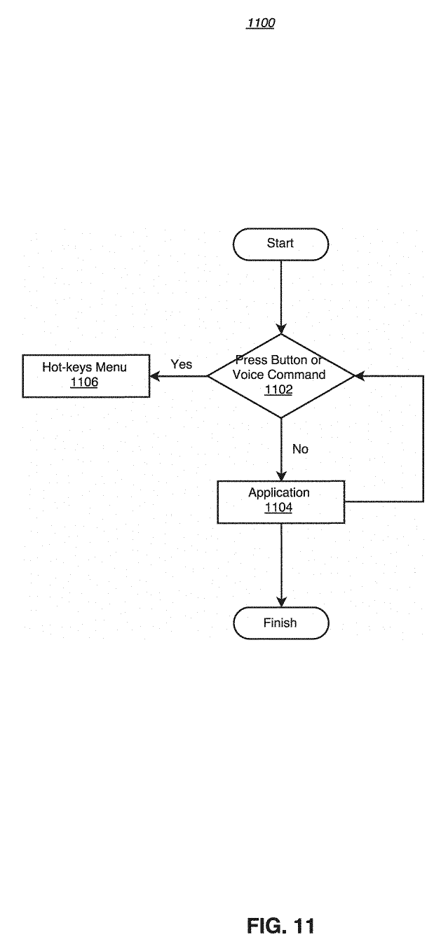

In some embodiments, to further simplify and short cut the task of navigating the GUI, a hot-keys menu may pop up, by a gesture, a button push or voice command, to display a short list of a subset of functions in the application and the corresponding controlling gestures. FIG. 9 schematically shows a process 900 of defining, assigning, and adjusting hot-keys controlled functions according to an exemplary embodiment. Each application 902 may contain many functions 904A, 904B, 904N, and certain functions may be designated hot-keys candidates by attaching a hot-keys tag to it (block 906). During system setup, the user may be allowed to select the functions among all tagged functions for inclusion in the hot-keys menu as illustrated in FIG. 9. For example, Function 904A attached with a hot-keys tag (block 902) may be assigned to the hot-keys menu (block 908). Once the hot-keys menu has been triggered by button push or voice 1102, the system may display a hot-keys menu, as described with respect to FIG. 11, and the user may use gesture control to adjust the parameter. Otherwise, the user needs to launch the application to access the full function.

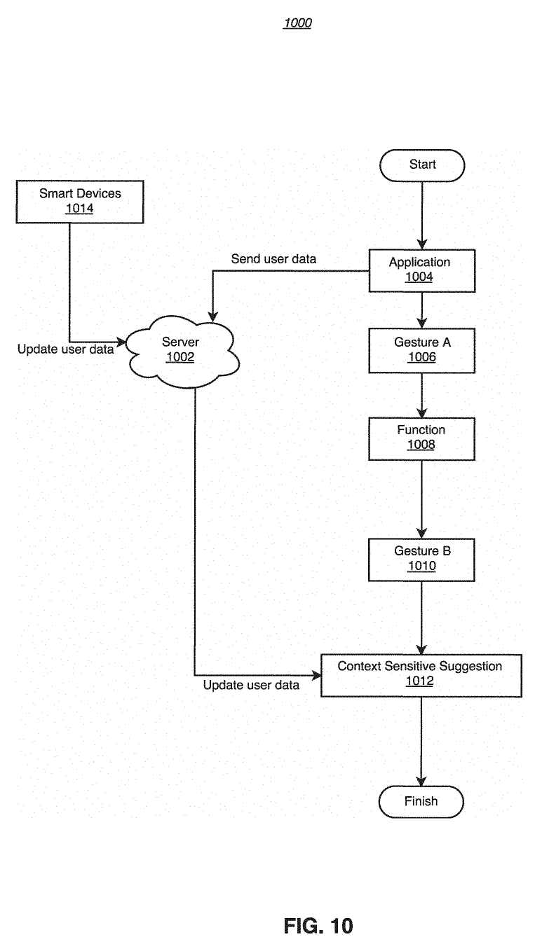

FIG. 10 is a flow diagram 1000 showing context sensitive suggestion integrated with gesture tracking GUI according to an exemplary embodiment. An application may be launched (block 1004). After the application is launched, the host processor 116 may communicate with the server to send and collect user's data relevant to the current activity (block 1002). The system 102 may detect gesture A (block 1006). In response to detecting gesture A, the system 102 may trigger a corresponding function (block 1008). The system 102 may also detect gesture B (block 1010) to trigger another function. In some embodiments, certain functions may require a user to enter certain data. For example, the navigation application may require the user to enter the address of the destination. An alternative solution is that since the server 104 has access to user's smart devices, the required information may be automatically provided to the application through the server 104. For example, the server 104 may access the user's smart device to obtain information from calendar and meeting schedule (block 1014). The server 104 may then present the location of the meeting scheduled to begin shortly to the user as a relevant context sensitive suggestion or default choice (block 1012). The context is driving to an appointment at a time specified in the calendar.

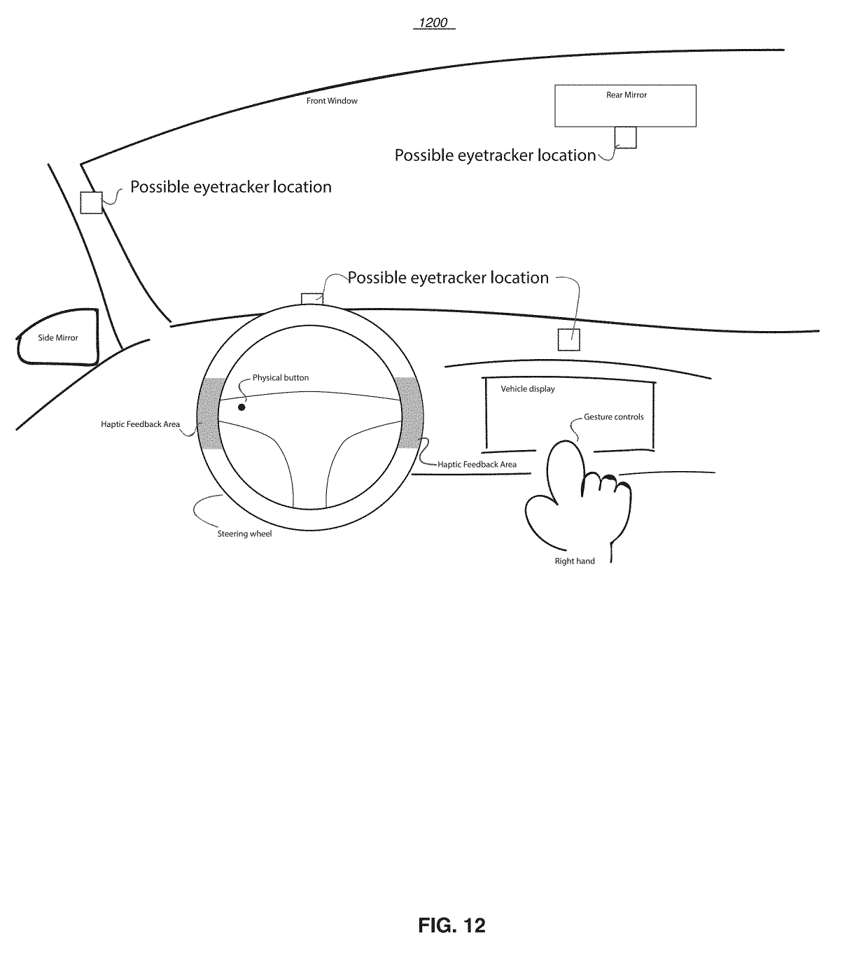

FIG. 11 is a flow diagram 1100 showing a combination of physical button and/or voice command with gesture tracking according to an exemplary embodiment. The system 102 and/or host processor 116 may combine gesture controls with button and/or voice command control. At block 1102, the system 102 and/or host processor 116 may determine whether a press of button or a voice command is received. For example, when a user uses left hand to press a physical button on the steering wheel (FIG. 12), the system may determine that a press of button is received. At block 1106, in response to a press of button or a voice command, a hot-keys menu may be triggered. For example, in response to receiving the press of the physical button on the steering wheel, the system 102 may trigger the hot-keys menu. At block 1104, in response to not receiving any button-press or voice command, an application may be controlled by gestures. For example, the system 102 may allow the user to user gesture control to adjust functions inside a menu.

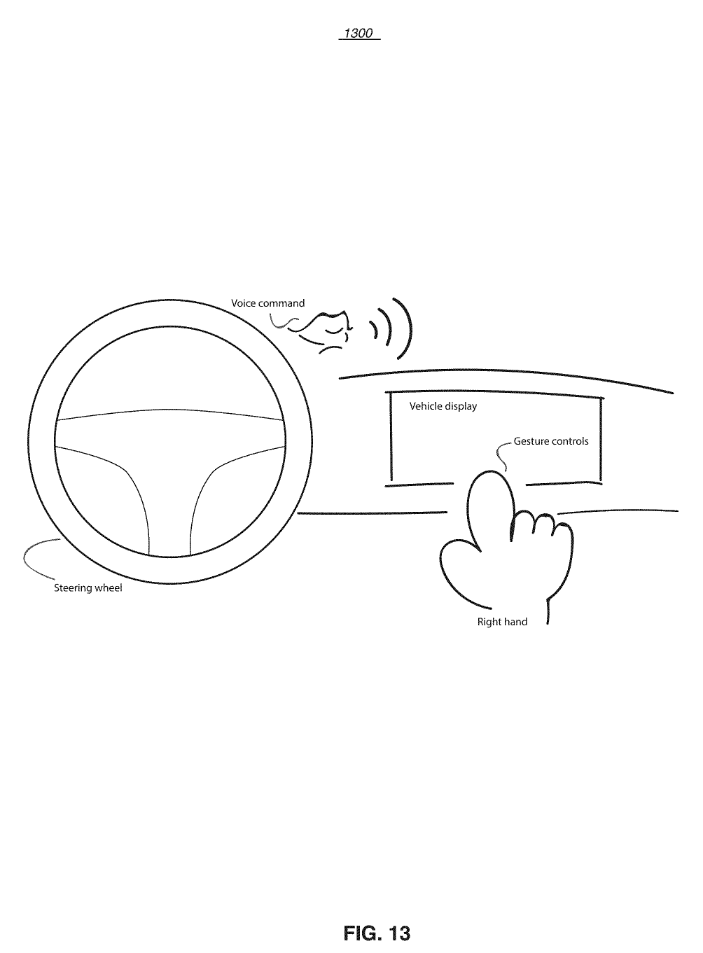

FIG. 12 is a diagram 1200 schematically showing a combination of physical button control, voice control and gesture control according to an exemplary embodiment. FIG. 13 is a diagram 1300 schematically showing a combination of voice and gesture control according to an exemplary embodiment. As shown in the diagrams 1300, 1400, the usage of physical button, voice command and/or the hand gesture may be combined to control the infotainment system of the car. Examples of the combinations may include, but are not limited to, button click once with hand gestures; button click twice with hand gestures; button click then holding with hand gestures; button holding with hand gesture; button click once with voice command; button click twice with voice command; button click then holding with voice command; button holding with voice command. Other combinations are possible.

In some embodiments, haptic feedback may be combined with gestures. Haptic feedback devices may include, but are not limited to, tactile vibration transducers in the steering wheel, ultrasound emitters, and air-pressure emitters. For example, the area of the steering wheel in frequent contact with a driver's hands may be equipped with tactile vibration transducers (FIG. 12). The entire steering wheel may also vibrate. The haptic feedback device is able to produce a number of different haptic feedback effects. For example, effects with different duration, different intensity, different frequency, and different modulation patterns. The haptic feedback may be controlled by the host processor 116, to provide feedback to the user during the human-computer interaction process. And under different conditions, the host processor 116 may trigger different types of haptic feedback. The system may trigger haptic feedback under, but not limited to, the following conditions: when the system changes gesture detection mode; when the system recognizes user's gesture; when the system recognizes an invalid gesture; when a user navigates to different cells in the UI grid; when the user clicks a virtual button; or when a user's hand moves into or out of gesture interaction zone.

An eye gaze tracker may be installed at many possible locations in front of the face of the occupants to monitor eye movement as illustrated in FIG. 12. The direction and point of gaze of occupants may be individually tracked. The eye gaze tracking may be realized by tracking eye movement directly, or by tracking head movement to estimate eye gaze direction. Tracking eye movement to determine the point of gaze, on or off the screen, may be used to change the brightness of the display and/or the content displayed on the screen. This may be used to reduce the glare of a bright screen (especially at night) or distraction in the peripheral vision area when the occupant is not looking directly at the screen. To further reduce distraction when occupants' eye gaze is not on the screen, the screen display may be turned static with little or no motion (e.g., freezing video), color muted (e.g., dimming, change color, no bright color, no blinking, no rapid change, etc.), totally turned off (off-state), and/or partially turned off with only essential information displayed (e.g., speed).

In addition to detecting whether the eye gaze is either on or off the screen (binary decision), the eye gaze tracker may track gaze with sufficient resolution to selectively perform the above mentioned actions on a portion of the screen. For example, when an occupant's gaze lands back on the screen currently in an off-state, the screen area surrounding the point of gaze will light up and the portion of the screen far away from the point of gaze will dim corresponding to the movement of the gaze; i.e., a moving spot-light effect to highlight only the portion of the screen an occupant is looking at. Such effect may respond to different occupants individually. For example, there may be two independent highlighted areas (spot lights) on the screen corresponding to the individual moving gaze of the driver and the passenger.

In some embodiments, eye gaze may also be used to turn on/off screen control gestures without explicit gesture or other forms of command/control. For example, the gesture control is turned on when the occupant looks at the screen and turned off when the occupant looks away.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for hand gesture based human-machine interaction with an automobile, the method comprising:
automatically starting a first mode of control of the automobile, wherein the first mode is associated with a first set of hand gestures, each hand gesture corresponding to a command for controlling the automobile;
determining whether a trigger event has been detected; and
in response to determining that the trigger event has been detected, performing control of the automobile in a second mode, wherein the second mode is associated with a second set of hand gestures, each hand gesture corresponding to a command for controlling the automobile, and
wherein the first set of hand gestures and the corresponding commands are a subset of the second set of hand gestures and the corresponding commands.

2. The method of claim 1, wherein the trigger event comprises one or more of a hand gesture, a voice, a push a physical button, and a combination thereof.

3. The method of claim 1, wherein in the second mode the method further comprises:
triggering a first command corresponding to a first hand gesture for controlling a first function of the automobile;
triggering a second command corresponding to a second hand gesture for controlling a second function of the automobile, wherein the second function is performed on a foreground of a screen of the automobile, and wherein the first function is paused on a background of the screen of the automobile;
detecting a switching signal, wherein the switching signal comprises one or more of a hand gesture, a voice, a push a physical button, and a combination thereof; and
in response to detecting the switching signal, switching the first function to be performed on the foreground and the second function to be paused on the background.

4. The method of claim 1, further comprising:
displaying an indicator on a screen of the automobile corresponding to a hand gesture of a user,
wherein the hand gesture comprises a fingertip and a wrist of the user, and a position of the indicator on the screen is determined based at least on a vector formed by positions of the fingertip and wrist.

5. The method of claim 4, wherein the screen of the automobile comprises a grid that has a plurality of blocks, and the indicator comprises one or more of the blocks.

6. The method of claim 4, further comprising:
capturing a first video frame at a first time, the first video frame including a first position and rotation of the fingertip;
capturing a second video frame at a second time, the second video frame including a second position and rotation of the fingertip;
comparing the first position and rotation of the fingertip and the second position and rotation of the fingertip to obtain a movement of the fingertip from the first time to the second time;
determining whether the movement of the fingertip is less than a pre-defined threshold; and
in response to determining that the movement of the fingertip is less than the pre-defined threshold, determining the position of the indication on the screen at the second time as the same as the position at the first time.

7. The method of claim 4, further comprising:
capturing a first video frame at a first time, the first video frame including a first position and rotation of the wrist;
capturing a second video frame at a second time, the second video frame including a second position and rotation of the wrist;
comparing the first position and rotation of the wrist and the second position and rotation of the wrist to obtain a movement of the wrist from the first time to the second time;
determining whether the movement of the wrist is less than a pre-defined threshold; and
in response to determining that the movement of the wrist is less than the pre-defined threshold, determining the position of the indication on the screen at the second time as the same as the position at the first time.

8. The method of claim 1, further comprising:
collecting data related to a user of the automobile,
wherein the commands corresponding to the hand gestures are also based at least on the collected data.

9. The method of claim 1, further comprising:
assigning a hot-keys tag to one or more functions of the automobile controlled by the commands; and
generating a hot-keys menu that comprises the one or more functions with hot-keys tags.

10. A system for hand gesture based human-machine interaction with an automobile, the system comprising:
one or more processors; and
a memory storing instructions that, when executed by the one or more processors, cause the system to perform:
automatically starting a first mode of control of the automobile, wherein the first mode is associated with a first set of hand gestures, each hand gesture corresponding to a command for controlling the automobile;
determining whether a trigger event has been detected; and
in response to determining that the trigger event has been detected, performing control of the automobile in a second mode, wherein the second mode is associated with a second set of hand gestures, each hand gesture corresponding to a command for controlling the automobile, and
wherein the first set of hand gestures and the corresponding commands are a subset of the second set of hand gestures and the corresponding commands.

11. The system of claim 10, wherein the trigger event comprises one or more of a hand gesture, a voice, a push a physical button, and a combination thereof.

12. The system of claim 10, wherein in the second mode the instructions cause the system to further perform:
triggering a first command corresponding to a first hand gesture for controlling a first function of the automobile;
triggering a second command corresponding to a second hand gesture for controlling a second function of the automobile, wherein the second function is performed on a foreground of a screen of the automobile, and wherein the first function is paused on a background of the screen of the automobile;
detecting a switching signal, wherein the switching signal comprises one or more of a hand gesture, a voice, a push a physical button, and a combination thereof; and
in response to detecting the switching signal, switching the first function to be performed on the foreground and the second function to be paused on the background.

13. The system of claim 10, wherein the instructions cause the system to further perform:
displaying an indicator on a screen of the automobile corresponding to a hand gesture of a user,
wherein the hand gesture comprises a fingertip and a wrist of the user, and a position of the indicator on the screen is determined based at least on a vector formed by positions of the fingertip and wrist.

14. The system of claim 13, wherein the screen of the automobile comprises a grid that has a plurality of blocks, and the indicator comprises one or more of the blocks.

15. The system of claim 13, wherein the instructions cause the system to further perform:
capturing a first video frame at a first time, the first video frame including a first position and rotation of the fingertip;
capturing a second video frame at a second time, the second video frame including a second position and rotation of the fingertip;
comparing the first position and rotation of the fingertip and the second position and rotation of the fingertip to obtain a movement of the fingertip from the first time to the second time;
determining whether the movement of the fingertip is less than a pre-defined threshold; and
in response to determining that the movement of the fingertip is less than the pre-defined threshold, determining the position of the indication on the screen at the second time as the same as the position at the first time.

16. The system of claim 13, wherein the instructions cause the system to further perform:
capturing a first video frame at a first time, the first video frame including a first position and rotation of the wrist;
capturing a second video frame at a second time, the second video frame including a second position and rotation of the wrist;
comparing the first position and rotation of the wrist and the second position and rotation of the wrist to obtain a movement of the wrist from the first time to the second time;
determining whether the movement of the wrist is less than a pre-defined threshold; and
in response to determining that the movement of the wrist is less than the pre-defined threshold, determining the position of the indication on the screen at the second time as the same as the position at the first time.

17. The system of claim 10, wherein the instructions cause the system to further perform:
collecting data related to a user of the automobile,
wherein the commands corresponding to the hand gestures are also based at least on the collected data.

18. The system of claim 10, wherein the instructions cause the system to further perform:
assigning a hot-keys tag to one or more functions of the automobile controlled by the commands; and
generating a hot-keys menu that comprises the one or more functions with hot-keys tags.

19. A non-transitory computer-readable storage medium coupled to a processor and comprising instructions that, when executed by the processor, cause the processor to perform a method for hand gesture based human-machine interaction with an automobile, the method comprising:
automatically starting a first mode of control of the automobile, wherein the first mode is associated with a first set of hand gestures, each hand gesture corresponding to a command for controlling the automobile;
determining whether a trigger event has been detected; and
in response to determining that the trigger event has been detected, performing control of the automobile in a second mode, wherein the second mode is associated with a second set of hand gestures, each hand gesture corresponding to a command for controlling the automobile, and
wherein the first set of hand gestures and the corresponding commands are a subset of the second set of hand gestures and the corresponding commands.

20. The non-transitory computer-readable storage medium of claim 19, wherein the trigger event comprises one or more of a hand gesture, a voice, a push a physical button, and a combination thereof.
